(19) United States
(12) Patent Application Publication
(10) Pub. No.: US 2022/0060723 A1
(43) Pub. Date: Feb. 24, 2022

(54) IMAGE PROCESSING DEVICE, IMAGE PROCESSING METHOD, AND IMAGE PROCESSING PROGRAM

(71) Applicant: SONY CORPORATION, TOKYO (JP)

(72) Inventor: KENJI KONDO, TOKYO (JP)

(21) Appl. No.: 17/250,301

(22) PCT Filed: Apr. 24, 2019
(86) PCT No.: PCT/JP2019/017519

§ 371 Date: Dec. 29, 2020

(30) Foreign Application Priority Data
Jul. 6, 2018 (JP) 2018-129522

(51) Int. Cl. H04N 19/176; H04N 19/124; H04N 19/159; H04N 19/60; H04N 19/18

(52) U.S. Cl. CPC H04N 19/176; H04N 19/124; H04N 19/18; H04N 19/60; H04N 19/159

(57) ABSTRACT

An image processing device 12 includes: an orthogonal transform unit 113 or 114 that executes orthogonal transform for a block obtained by dividing an image; and a control unit 101 or 212 that controls the orthogonal transform unit depending on whether or not the number of pixels in a height direction or a width direction of the block is a power of 2.

### FIELD

The present disclosure relates to an image processing device, an image processing method, and an image processing program.

### BACKGROUND

In Joint Video Exploration Team (JVET) that explores next-generation video coding of International Telecommunication Union Telecommunication Standardization Sector (ITU-T), it has been proposed to make a Coding Unit (CU) and a Transform Unit (TU) be the same as each other for simplification of processing. That is, it has been proposed to execute orthogonal transform and inverse orthogonal transform in units of the CU.

Conventionally, the orthogonal transform and the inverse orthogonal transform have been executed in units of a TU obtained by dividing the CU. Then, the TU has been divided so that the number of pixels in a height direction or a width direction was a power of 2. For this reason, the orthogonal transform and the inverse orthogonal transform have not been executed in units in which the number of pixels in the height direction or the width direction is not the power of 2.

### CITATION LIST

### Non Patent Literature

Non Patent Literature 1: Teruhiko Suzuki, Masaru Ikeda, Karl Sharman, “Description of SDR and HDR video coding technology proposal by Sony (JVET-J0028)” JVET of ITU-T SG 16 WP 3 and ISO/IEC JTC 1/SC 29/WG 11 10-20 Apr. 2018

### SUMMARY

### Technical Problem

By the way, in order to improve coding compressibility, it is necessary to increase a variation of block division of the CU. In the variation of the block division of the CU, a case where the number of pixels in the width direction or the height direction of a divided block is not the power of 2 is also assumed. However, in a case where the orthogonal transform and the inverse orthogonal transform are executed in units of a TU obtained by dividing the CU, it has not been assumed that the number of pixels of a target block of the orthogonal transform and the inverse orthogonal transform is not the power of 2. For this reason, in a case where the orthogonal transform or the inverse orthogonal transform is executed for a block when the number of pixels in the height direction or the width direction is the power of 2, a processing amount is increased.

Therefore, the present disclosure proposes an image processing device, an image processing method, and an image processing program capable of suppressing an increase in a processing amount even in a case where the number of pixels in a width direction or a height direction of a block is not a power of 2.

### Solution to Problem

To solve the problem described above, an image processing device includes: an orthogonal transform unit that executes orthogonal transform for a block obtained by dividing an image; and a control unit that controls the orthogonal transform unit depending on whether or not the number of pixels in a height direction or a width direction of the block is a power of 2.

### Advantageous Effects of Invention

According to the present disclosure, it is possible to suppress an increase in a processing amount even in a case where the number of pixels in a width direction or a height direction of a block is not a power of 2. Note that an effect described here is not necessarily limited, and may be any effect described in the present disclosure.

### BRIEF DESCRIPTION OF DRAWINGS

FIG. 1 is a block diagram illustrating a configuration example of an embodiment of an image processing system according to a first embodiment of the present disclosure.

FIG. 2 is a diagram for describing processing performed in a coding circuit according to the first embodiment of the present disclosure.

FIG. 3 is a diagram illustrating processing performed in a decoding circuit according to the first embodiment of the present disclosure.

FIG. 4 is a block diagram illustrating a configuration example of an embodiment of an image coding device according to the first embodiment of the present disclosure.

FIG. 5 is a block diagram illustrating a configuration example of an embodiment of an image decoding device according to the first embodiment of the present disclosure.

FIG. 6 is a flowchart for describing image coding processing executed by the image coding device 12 according to the first embodiment of the present disclosure.

FIG. 7 is a flowchart for describing image decoding processing executed by the image decoding device 13 according to the first embodiment of the present disclosure.

FIG. 8 is a diagram (1) illustrating an example of block division of a Coding Unit (CU) according to the first embodiment of the present disclosure.

FIG. 9 is a diagram (2) illustrating an example of block division of a CU according to the first embodiment of the present disclosure.

FIG. 10 is a diagram illustrating a variation of the block division of the CU according to the first embodiment of the present disclosure.

FIG. 11 is a diagram illustrating an example before and after division of the CU according to the first embodiment of the present disclosure.

FIG. 12 is a flowchart illustrating an example of coding processing according to the first embodiment of the present disclosure.

FIG. 13 is a flowchart illustrating an example of decoding processing according to the first embodiment of the present disclosure.

FIG. 14 is a flowchart illustrating an example of coding processing according to a first modification of the first embodiment of the present disclosure.

FIG. 15 is a flowchart illustrating an example of decoding processing according to the first modification of the first embodiment of the present disclosure.

FIG. 16 is a flowchart illustrating an example of coding processing according to a second modification of the first embodiment of the present disclosure.

FIG. 17 is a flowchart illustrating an example of coding processing according to a second embodiment of the present disclosure.

FIG. 18 is a diagram illustrating an example of a division aspect of a CU according to the second embodiment of the present disclosure.

FIG. 19 is a diagram illustrating an example of a division aspect of a CU according to the second embodiment of the present disclosure.

FIG. 20 is a diagram illustrating an example of a division aspect of a CU according to the second embodiment of the present disclosure.

FIG. 21 is a diagram illustrating a processing procedure of orthogonal transform for a CU in which the numbers of pixels in a height direction and a width direction according to a third embodiment of the present disclosure are a power of 2.

FIG. 22 is a diagram illustrating a CU in which the number of pixels in the height direction according to the third embodiment of the present disclosure is not the power of 2.

FIG. 23 is a diagram illustrating a CU in which the number of pixels in the width direction according to the third embodiment of the present disclosure is not the power of 2.

FIG. 24 is a diagram illustrating an example of a variation of a region in which orthogonal transform is executed according to a fourth embodiment of the present disclosure.

FIG. 25 is a flowchart illustrating an example of coding processing according to the fourth embodiment of the present disclosure.

FIG. 26 is a flowchart illustrating an example of decoding processing according to the fourth embodiment of the present disclosure.

FIG. 27 is a diagram illustrating an example of a variation of a region in which orthogonal transform is executed according to the fourth embodiment of the present disclosure.

FIG. 28 is a diagram illustrating an example of a case where orthogonal transform is recursively executed in a maximum region in which the number of pixels is a power of 2 with respect to a region remaining in the orthogonal transform according to a first modification of the fourth embodiment of the present disclosure.

FIG. 29 is a diagram illustrating an example of a case where orthogonal transform is recursively executed in a maximum region in which the number of pixels is a power of 2 with respect to a region remaining in the orthogonal transform according to the first modification of the fourth embodiment of the present disclosure.

FIG. 30 is a block diagram illustrating a configuration example of an embodiment of a computer on which a program for executing the series of processing described above is installed.

### DESCRIPTION OF EMBODIMENTS

Hereinafter, embodiments of the present disclosure will be described in detail with reference to the drawings. Note that in each of the following embodiments, the same portions will be denoted by the same reference numerals and an overlapping description thereof will be omitted.

### Literatures or the Like that Support Technical Contents and Technical Terms

A scope disclosed in the present technology includes not only contents described in embodiments but also contents described in the following Non Patent Literatures known at the time of filing the present technology.
Non Patent Literature 1: (described above)
Non Patent Literature 2: TELECOMMUNICATION STANDARDIZATION SECTOR OF ITU (International Telecommunication Union), “High efficiency video coding”, H.265, December 2016
Non Patent Literature 3: TELECOMMUNICATION STANDARDIZATION SECTOR OF ITU (International Telecommunication Union), “Advanced video coding for generic audiovisual services”, H.264, April 2017

That is, the contents described in Non Patent Literatures 1 to 3 described above are also bases at the time of determining support requirements. For example, a Quad Tree Plus Binary Tree (QTBT) Block StrucTUre described in Non Patent Literature 1 or a Quad-Tree Block StrucTUre described in Non Patent Literature 2 is considered to be within the disclosure scope of the present technology and satisfy the support requirements of the claims even in a case where it is not directly described in embodiments. Similarly, for example, technical terms such as parsing, syntax, semantics, and the like, are also considered to be within the disclosure scope of the present technology and satisfy the support requirements of the claims, even in a case where they are not directly described in embodiments.

### Terms

In the present application, the following terms are defined as follows.

<Block>

A “block” (that is not a block indicating a processor) used for a description as a partial region or a unit of processing of an image (picture) indicates an arbitrary partial region in the picture unless mentioned otherwise, and a size, a shape, characteristics, and the like, of the region are not limited. For example, the “block” is considered to include an arbitrary partial region (unit of processing) such as a Transform Block (TB), a Transform Unit (TU), a Prediction Block (PB), a Prediction Unit (PU), a Smallest Coding Unit (SCU), a Coding Unit (CU), a Largest Coding Unit (LCU), a Coding Tree Block (CTB), a Coding Tree Unit (CTU), a transform block, a subblock, a macroblock, a tile, a slice, or the like.

<Designation of Block Size>

In addition, in a designating a size of such a block, the block size is not only directly designated, but may also be indirectly designated. For example, the block size may be designated using identification information for identifying a size. In addition, the block size may be designated by, for example, a ratio or a difference with a size of a reference block (for example, the LCU, the SCU or the like). For example, in a case of transmitting information for designating the block size as a syntax element or the like, information for indirectly designating the size as described above may be used as the information. In this way, an information amount of the information can be reduced, and coding efficiency may be improved. In addition, this designation of the block size also includes designation of a range of the block size (for example, designation of a range of an allowable block size, or the like).

<Information/Processing Unit>

Each of data units in which various information is set or data units that various processing targets is arbitrary and is not limited to the example described above. For example, each of these pieces of information or processing may be set for each Transform Unit (TU), each Transform Block (TB), each Prediction Unit (PU), each Prediction Block (PB), each Coding Unit (CU), each Largest Coding Unit (LCU), each subblock, each block, each title, each slice, each picture, each sequence, or each component, and may target data of those data units. Of course, this data unit can be set for each information or processing, and it is not necessary that data units of all information or processing are unified. Note that a storage place of these pieces of information is arbitrary and these pieces of information may be stored in a header, a parameter set or the like of the data unit described above. In addition, these pieces of information may be stored in a plurality of places.

<Control Information>

Control information regarding the present technology may be transmitted from a coding side to a decoding side. For example, control information (for example, enabled_flag) for controlling whether or not to an application of the present technology described above is permitted (or prohibited) may be transmitted. In addition, for example, control information indicating a target to which the present technology described above is applied (or a target to which the present technology described above is not applied) may be transmitted. For example, control information for designating a block size (an upper lower or a lower limit or both of the upper limit and the lower limit), a frame, a component, a layer, or the like, to which the present technology is applied (application of the present technology is permitted or prohibited) may be transmitted.

<Flag>

Note that in the present specification, a “flag” is information for identifying a plurality of states and includes not only information used for identifying two states of true (1) or false (0) but also information capable of identifying three or more states. Therefore, a value that the “flag” can take may be, for example, 2 values of 1 and 0, or 3 or more values. That is, the number of bits constituting the “flag” is arbitrary, and may be 1 bit or a plurality of bits. In addition, identification information (including the flag) is assumed to have not only a form of including the identification information in a bit stream but also a form of including difference information of the identification information with respect to certain reference information in a bit stream, and the “flag” or the “identification information” in the present specification thus includes not only the information but also the difference information with respect to the reference information.

<Associate Metadata>

In addition, various information (metadata or the like) regarding coded data (bit stream) may be transmitted or recorded in any form as long as it is associated with the coded data. Here, the term “associate” means, for example, to make the other data available (linkable) at the time of processing one data. That is, data associated with each other may be combined as one data or may be individual data, respectively. For example, information associated with coded data (image) may be transmitted on a transmission path different from a transmission path of the coded data (image). In addition, for example, the information associated with the coded data (image) may be recorded on a recording medium (or another recording area of the same recording medium) different from a recoding medium of the coded data (image). Note that the “association” is not the entirety of the data, and may be a part of the data. For example, an image and information corresponding to the image may be associated with each other in an arbitrary unit such as a plurality of frames, one frame, a part in the frame, or the like.

Note that in the present specification, terms such as “synthesize”, “multiplex”, “add”, “integrate”, “include”, “store”, “insert”, or the like, means combining a plurality of objects into one such as combining coded data and metadata into one data, and means one method of “associate” described above.

Hereinafter, embodiments of the present disclosure will be described in detail with reference to the drawings. Note that in each of the following embodiments, the same portions will be denoted by the same reference numerals and an overlapping description thereof will be omitted.

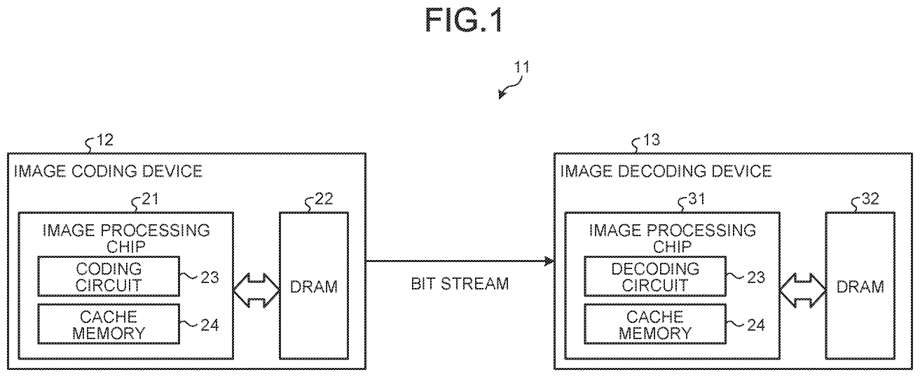

### First Embodiment

[Configuration of Image Processing System According to First Embodiment] An outline of the present technology will be described with reference to FIGS. 1 to 5.

FIG. 1 is a block diagram illustrating a configuration example of an embodiment of an image processing system according to a first embodiment of the present disclosure.

As illustrated in FIG. 1, an image processing system 11 includes an image coding device 12 and an image decoding device 13. For example, in the image processing system 11, an image captured by an image capturing device (not illustrated) is input to the image coding device 12, and is coded by the image coding device 12, such that coded data is generated. As a result, in the image processing system 11, the coded data is transmitted as a bit stream from the image coding device 12 to the image decoding device 13. Then, in the image processing system 11, the coded data is decoded in the image decoding device 13, such that an image is generated and is displayed on a display device (not illustrated).

The image coding device 12 has a configuration in which an image processing chip 21 and an external memory 22 are connected to each other via a bus.

The image processing chip 21 includes a coding circuit 23 that codes an image and a cache memory 24 that temporarily stores data required for the coding circuit 23 to code the image.

The external memory 22 is composed of, for example, a dynamic random access memory (DRAM), and stores image data to be coded by the image coding device 12 for each frame.

For example, in the image coding device 12, data divided for each CU, which is a unit of processing in which coding is performed, among image data for one frame stored in the external memory 22 is read into the cache memory 24. Then, in the image coding device 12, coding is performed by the coding circuit 23 for each CU stored in the cache memory 24, such that coded data is generated.

The image decoding device 13 has a configuration in which an image processing chip 31 and an external memory 32 are connected to each other via a bus.

The image processing chip 31 includes a decoding circuit 33 that decodes the coded data to generate an image and a cache memory 34 that temporarily stores data required for the decoding circuit 33 to decode the coded data.

The external memory 32 is composed of, for example, a DRAM, and stores the coded data to be decoded in the image decoding device 13 for each frame of the image.

Then, in the image decoding device 13, an image is generated by decoding the coded data by the decoding circuit 33 for each CU stored in the cache memory 34.

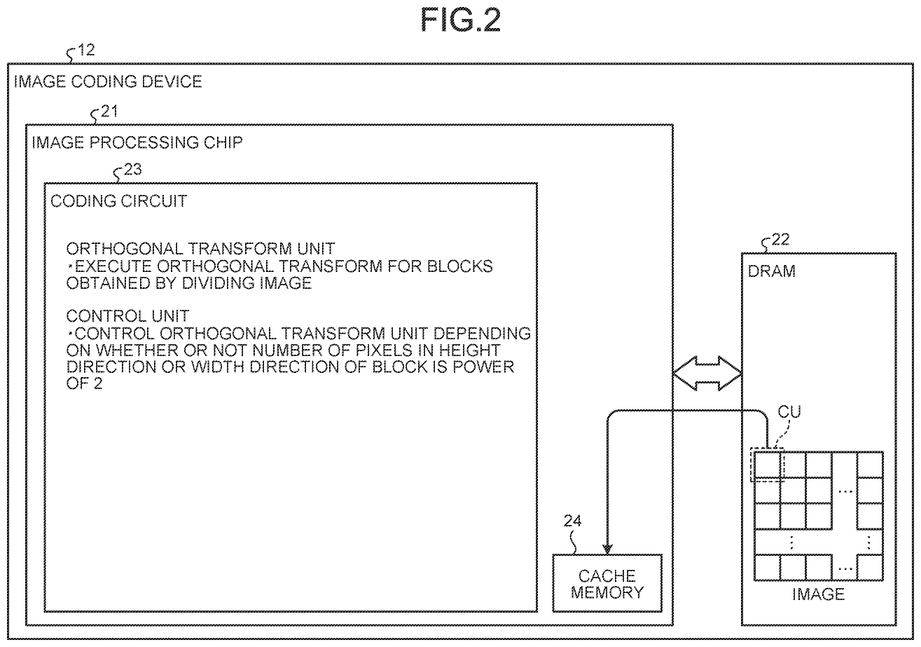

Here, FIG. 2 is a diagram for describing processing performed in the coding circuit according to the first embodiment of the present disclosure. Processing performed by the coding circuit 23 of the image coding device 12, which is an example of an image processing device, will be further described with reference to FIG. 2.

For example, the coding circuit 23 is designed to function as an orthogonal transform unit and a control unit as illustrated. Note that a case where the orthogonal transform unit and the control unit are realized by the coding circuit 23 is assumed and described in FIG. 2, but the orthogonal transform unit and the control unit may be realized by other forms such as software or the like. For example, the coding circuit 23 includes a central processing unit (CPU) and a storage device in which a program is stored, as hardware elements, and functions of the orthogonal transform unit and the control unit may be realized by executing the program by the CPU. In addition, the present disclosure is not limited thereto, and some or all of the orthogonal transform unit and the control unit may be realized by a dedicated hardware circuit. Further, the orthogonal transform unit and the control unit may be realized by mixing hardware and software with each other.

That is, the coding circuit 23 executes orthogonal transform for a block obtained by dividing the image. In addition, the coding circuit 23 controls the orthogonal transform unit depending on whether or not the number of pixels in a height direction or a width direction of the block is a power of 2.

More specifically, the coding circuit 23 executes the orthogonal transform in units of a CU, that is, a block, obtained by dividing the image. In this case, the coding circuit 23 divides the image regardless of whether or not the number of pixels in the height direction or the width direction of the CU after the division is the power of 2. Then, the coding circuit 23 can execute the orthogonal transform at a high speed with a small amount of calculation by fast Fourier transform in a case where the numbers of pixels in the height direction and the width direction of the CU are the power of 2. However, the coding circuit 23 cannot use the fast Fourier transform in a case where the numbers of pixels in the height direction and the width direction of the CU are not the power of 2. For this reason, the coding circuit 23 suppresses that a processing amount increases, such that a processing speed decreases, by controlling the orthogonal transform depending on whether or not the number of pixels in the height direction or the width direction of the CU after the division is the power of 2.

Then, the coding circuit 23 outputs a bit stream including various information such as division information indicating a division form of the CU, and the like.

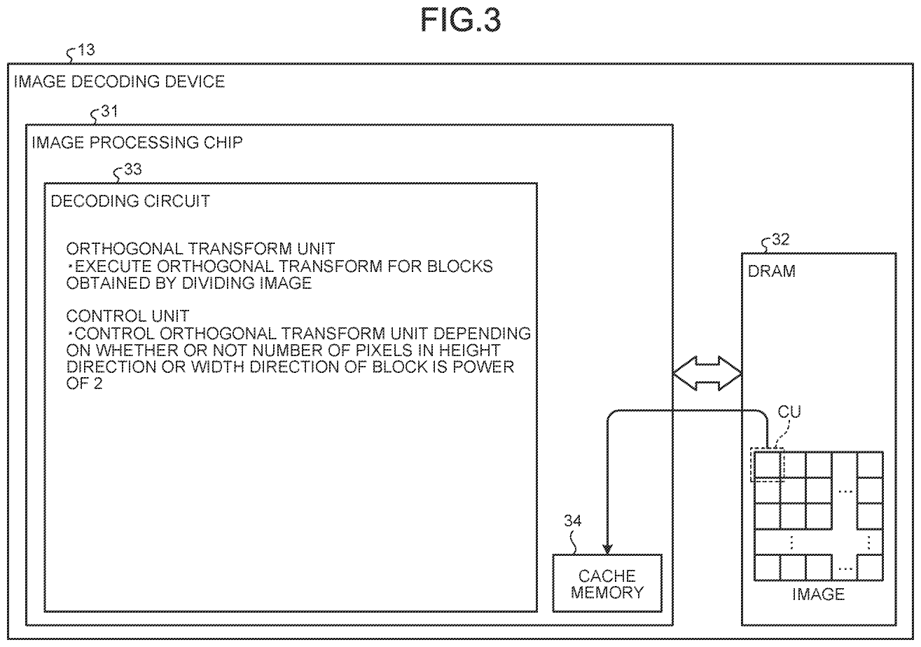

Here, FIG. 3 is a diagram for describing processing performed in the decoding circuit according to the first embodiment of the present disclosure. Processing performed by the decoding circuit 33 of the image decoding device 13, which is an example of an image processing device, will be further described with reference to FIG. 3.

For example, the decoding circuit 33 is designed to function as an orthogonal transform unit and a control unit as illustrated. Note that a case where the orthogonal transform unit and the control unit are realized by the decoding circuit 33 is assumed and described in FIG. 3, but the orthogonal transform unit and the control unit may be realized by other forms such as software or the like. In addition, also in the decoding circuit 33, similar to the coding circuit 23 described above, functions of the orthogonal transform unit and the control unit may be realized by a CPU executing a program. In addition, some or all of the orthogonal transform unit and the control unit may be realized by a dedicated hardware circuit. Further, the orthogonal transform unit and the control unit may be realized by mixing hardware and software with each other.

That is, the decoding circuit 33 executes orthogonal transform for a block obtained by dividing the image. In addition, the coding circuit 23 controls the orthogonal transform unit depending on whether or not the number of pixels in a height direction or a width direction of the block is a power of 2.

Here, the inverse orthogonal transform is a concept included in the orthogonal transform in a broad sense, and is one form of the orthogonal transform. That is, the decoding circuit 33 executes the inverse orthogonal transform, which is one form of the orthogonal transform, for the block obtained by dividing the image. In addition, the coding circuit 23 controls the orthogonal transform unit executing the inverse orthogonal transform, which is one form of the orthogonal transform, depending on whether or not the number of pixels in the height direction or the width direction of the block is the power of 2.

More specifically, the decoding circuit 33 extracts various information including the division information indicating the division form of the CU from the bit stream output from the image coding device 12. The decoding circuit 33 executes the inverse orthogonal transform, which is one form of the orthogonal transform, in units of a CU, that is, a block, obtained by dividing the image. In this case, the coding circuit 23 executes the orthogonal transform depending on whether or not the numbers of pixels in the height direction and the width direction of the CU are the power of 2, and outputs an execution result as a bit stream together with various information regarding the orthogonal transform. The decoding circuit 33 controls the orthogonal transform unit that executes the inverse orthogonal transform, which is one form of orthogonal transform, by various information regarding the orthogonal transform included in the bit stream. That is, the decoding circuit 33 controls the orthogonal transform unit depending on whether or not the number of pixels in the height direction or the width direction of the block is the power of 2. For this reason, the coding circuit 23 can suppress that a processing amount increases, such that a processing speed decreases.

[Configuration Example of Image Coding Device According to First Embodiment]

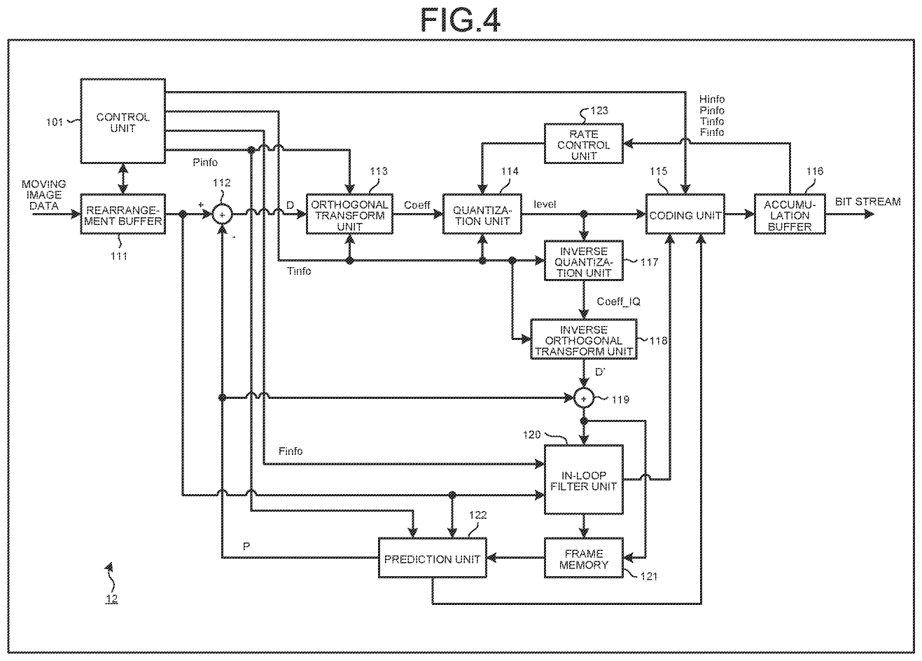

FIG. 4 is a block diagram illustrating a configuration example of an embodiment of the image coding device according to the first embodiment of the present disclosure.

The image coding device 12 illustrated in FIG. 4 is a device that codes image data of a moving image. For example, the image coding device 12 implements technologies described in Non Patent Literature 1, Non Patent Literature 2, or Non Patent Literature 3 and codes the image data of the moving image by a method conforming to a standard described in any one of those Non Patent Literatures.

Note that FIG. 4 illustrates main portions such as processing units, data flows or the like, and those illustrated in FIG. 4 are not all. That is, in the image coding device 12, there may be a processing unit that is not illustrated as a block in FIG. 4 or there may be processing or a data flow that is not illustrated as an arrow or the like in FIG. 4.

As illustrated in FIG. 4, the image coding device 12 is configured to include a control unit 101, a rearrangement buffer 111, a calculation unit 112, an orthogonal transform unit 113, a quantization unit 114, a coding unit 115, an accumulation buffer 116, an inverse quantization unit 117, an inverse orthogonal transform unit 118, a calculation unit 119, an in-loop filter unit 120, a frame memory 121, a prediction unit 122, and a rate control unit 123. Note that the prediction unit 122 includes an intra-prediction unit (not illustrated) and an inter-prediction unit (not illustrated). The image coding device 12 is a device for generating coded data (bit stream) by coding moving image data.

<Control Unit>

The control unit 101 divides the moving image data held by the rearrangement buffer 111 into blocks (CUs, PUs, transform blocks, or the like) of a unit of processing based on a block size of an external or predetermined unit of processing. In addition, the control unit 101 determines coding parameters (header information Hinfo, prediction mode information Pinfo, transform information Tinfo, filter information Finfo, and the like) to be supplied to each block based on, for example, Rate-Distortion Optimization (RDO).

Details of these coding parameters will be described later. When the control unit 101 determines the coding parameter as described above, the control unit 101 supplies the coding parameter to each block. Specifically, it is as follows.

The header information Hinfo is supplied to each block.

The prediction mode information Pinfo is supplied to the coding unit 115 and the prediction unit 122.

The transform information Tinfo is supplied to the coding unit 115, the orthogonal transform unit 113, the quantization unit 114, the inverse quantization unit 117, and the inverse orthogonal transform unit 118.

The filter information Finfo is supplied to the in-loop filter unit 120.

<Rearrangement Buffer>

Each field (input image) of the moving image data is input to the image coding device 12 in reproduction order (display order). The rearrangement buffer 111 acquires and holds (stores) each input image in the reproduction order (display order). The rearrangement buffer 111 rearranges the input images in coding order (decoding order) or divides the input images into blocks of units of processing based on the control of the control unit 101. The rearrangement buffer 111 supplies each processed input image to the calculation unit 112. In addition, the rearrangement buffer 111 also supplies each input image (original image) to the prediction unit 122 and the in-loop filter unit 120.

<Calculation Unit>

The calculation unit 112 takes an image I corresponding to the block of the unit of processing and a prediction image P supplied from the prediction unit 122 as inputs, subtracts the prediction image P from the image I to derive a prediction residual D (D=I−P), and supplies the prediction residual to the orthogonal transform unit 113.

<Orthogonal Transform Unit>

The orthogonal transform unit 113 takes the prediction residual D supplied from the calculation unit 112 and the transform information Tinfo supplied from the control unit 101 as inputs, and performs orthogonal transform on the prediction residual D based on the transform information Tinfo to derive a transform coefficient Coeff. The orthogonal transform unit 113 supplies the obtained transform coefficient Coeff to the quantization unit 114.

<Quantization Unit>

The quantization unit 114 takes the transform coefficient Coeff supplied from the orthogonal transform unit 113 and the transform information Tinfo supplied from the control unit 101 as inputs, and scales (quantizes) the transform coefficient Coeff based on the transform information Tinfo. Note that a rate of this quantization is controlled by the rate control unit 123. The quantization unit 114 supplies the quantized transform coefficient obtained by such quantization, that is, a quantization transform coefficient level level, to the coding unit 115 and the inverse quantization unit 117.

<Coding Unit>

The coding unit 115 takes the quantization transform coefficient level level supplied from the quantization unit 114, various coding parameters (header information Hinfo, prediction mode information Pinfo, transform information Tinfo, filter information Finfo, and the like) supplied from the control unit 101, information regarding a filter such as a filter coefficient or the like supplied from the in-loop filter unit 120, and information regarding an optimum prediction mode supplied from the prediction unit 122 as inputs. The coding unit 115 performs variable length coding (for example, arithmetic coding) of the quantization transform coefficient level level to generate a bit string (coded data).

In addition, the coding unit 115 derives residual information Rinfo from the quantization transform coefficient level level, and codes the residual information Rinfo to generate a bit string.

Further, the coding unit 115 includes the information regarding the filter supplied from the in-loop filter unit 120 in the filter information Finfo, and includes the information regarding the optimum prediction mode supplied from the prediction unit 122 in the prediction mode information Pinfo. Then, the coding unit 115 codes the various coding parameters (header information Hinfo, prediction mode information Pinfo, transform information Tinfo, filter information Finfo, and the like) described above to generate a bit string.

In addition, the coding unit 115 multiplexes the bit strings of the various information generated as described above to generate a coded data. The coding unit 115 supplies the coded data to the accumulation buffer 116.

In addition to these, the coding unit 115 can code orthogonal transform maximum size identification information supplied from the control unit 101 to generate a bit string, multiplex the bit string to generate coded data. As a result, as described above with reference to FIG. 1, the coded data (bit stream) including the orthogonal transform maximum size identification information is transmitted.

<Accumulation Buffer>

The accumulation buffer 116 temporarily holds the coded data obtained by the coding unit 115. The accumulation buffer 116 outputs the held coded data as, for example, a bit stream or the like to the outside of the image coding device 12 at a predetermined timing. For example, this coded data is transmitted to a decoding side via an arbitrary recording medium, an arbitrary transmission medium, an arbitrary information processing device, or the like. That is, the accumulation buffer 116 is also a transmission unit that transmits the coded data (bit stream).

<Inverse Quantization Unit>

The inverse quantization unit 117 performs processing regarding inverse quantization. For example, the inverse quantization unit 117 takes the quantization transform coefficient level level supplied from the quantization unit 114 and the transform information Tinfo supplied from the control unit 101 as inputs, and scales (inverse quantization) a value of the quantization transform coefficient level level based on the transform information Tinfo. Note that this inverse quantization is inverse processing of the quantization performed in the quantization unit 114. The inverse quantization unit 117 supplies a transform coefficient Coeff_IQ obtained by such inverse quantization to the inverse orthogonal transform unit 118.

<Inverse Orthogonal Transform Unit>

The inverse orthogonal transform unit 118 performs processing regarding inverse orthogonal transform. Here, the inverse orthogonal transform is one aspect of the orthogonal transform. For example, the inverse orthogonal transform unit 118 takes the transform coefficient Coeff_IQ supplied from the inverse quantization unit 117 and the transform information Tinfo supplied from the control unit 101 as inputs, and performs the inverse orthogonal transform on the transform coefficient Coeff_IQ based on the transform information Tinfo to derive a prediction residual D′. Note that this inverse orthogonal transform is inverse processing of the orthogonal transform performed by the orthogonal transform unit 113. The inverse orthogonal transform unit 118 supplies the prediction residual D′ obtained by such inverse orthogonal transform to the calculation unit 119. Note that the inverse orthogonal transform unit 118 is similar to an inverse orthogonal transform unit (to be described later) on the decoding side, and a description (to be described later) provided for the decoding side can thus be applied to the inverse orthogonal transform unit 118.

<Calculation Unit>

The calculation unit 119 takes the prediction residual D′ supplied from the inverse orthogonal transform unit 118 and the prediction image P supplied from the prediction unit 122 as inputs. The calculation unit 119 adds the prediction residual D′ to the prediction image P corresponding to the prediction residual D′ to derive a locally decoded image R_{local} (R_{local}=D′+P). The calculation unit 119 supplies the derived locally decoded image R_{local} to the in-loop filter unit 120 and the frame memory 121.

<In-Loop Filter Unit>

The in-loop filter unit 120 performs processing regarding in-loop filter processing. For example, the in-loop filter unit 120 inputs the locally decoded image R_{local} supplied from the calculation unit 119, the filter information Finfo supplied from the control unit 101, and the input image (original image) supplied from the rearrangement buffer 111. Note that the information input to the in-loop filter unit 120 is arbitrary, and information other than these pieces of information may be input to the in-loop filter unit 120. For example, if necessary, information or the like of a prediction mode, motion information, a code amount target value, a quantization parameter QP, a picture type, and a block (CU, CTU or the like) may be input to the in-loop filter unit 120.

The in-loop filter unit 120 performs appropriate filter processing on the locally decoded image R_{local} based on the filter information Finfo. The in-loop filter unit 120 also uses the input image (original image) or other input information for the filter processing, if necessary.

For example, the in-loop filter unit 120 applies four in-loop filters such as a bilateral filter, a deblocking filter (DBF), an adaptive offset filter (sample adaptive offset (SAO)), and an adaptive loop filter (ALF) in this order, as described in Non Patent Literature 1. Note that which filter is applied and which order the filters are applied is arbitrary and can be appropriately selected.

Of course, the filter processing performed by the in-loop filter unit 120 is arbitrary and is not limited to the example described above. For example, the in-loop filter unit 120 may apply a Wiener filter or the like.

The in-loop filter unit 120 supplies the filter-processed locally decoded image R_{local} to the frame memory 121. Note that in a case of transmitting the information regarding the filter such as the filter coefficient or the like to the decoding side, the in-loop filter unit 120 supplies the information regarding the filter to the coding unit 115.

<Frame Memory>

The frame memory 121 performs processing regarding storage of data regarding the image. For example, the frame memory 121 takes and holds (stores) the locally decoded image R_{local} supplied from the calculation unit 119 or the filter-processed locally decoded image R_{local} supplied from the in-loop filter unit 120 as an input. In addition, the frame memory 121 reconstructs a decoded image R for each picture unit using the locally decoded image R_{local}, and holds the decoded image R (stores the decoded image R in a buffer in the frame memory 121). The frame memory 121 supplies the decoded image R (or a part of the decoded image) to the prediction unit 122 according to a request of the prediction unit 122.

<Prediction Unit>

The prediction unit 122 performs processing regarding generation of the prediction image P. For example, the prediction unit 122 takes the prediction mode information Pinfo supplied from the control unit 101, the input image (original image) supplied from the rearrangement buffer 111, and the decoded image R (or a part of the decoded image) read from the frame memory 121 as inputs. The prediction unit 122 performs prediction processing such as inter-prediction or intra-prediction using the prediction mode information Pinfo or the input image (original image), performs prediction by referring to the decoded image R as a reference image, and performs motion compensation processing based on the prediction result to generate the prediction image P. The prediction unit 122 supplies the generated prediction image P to the calculation unit 112 and the calculation unit 119. In addition, the prediction unit 122 supplies information regarding the prediction mode selected by the above processing, that is, the optimum prediction mode, to the coding unit 115, if necessary.

<Rate Control Unit>

The rate control unit 123 performs processing regarding rate control. For example, the rate control unit 123 controls a rate of a quantization operation of the quantization unit 114 based on a code amount of the coded data accumulated in the accumulation buffer 116 so that an overflow or an underflow does not occur.

Note that each processing performed as a setting unit and the orthogonal transform unit in the coding circuit 23 as described above with reference to FIG. 2 is not individually performed in each block illustrated in FIG. 4, and may be performed by, for example, a plurality of blocks.

[Configuration Example of Image Decoding Device According to First Embodiment]

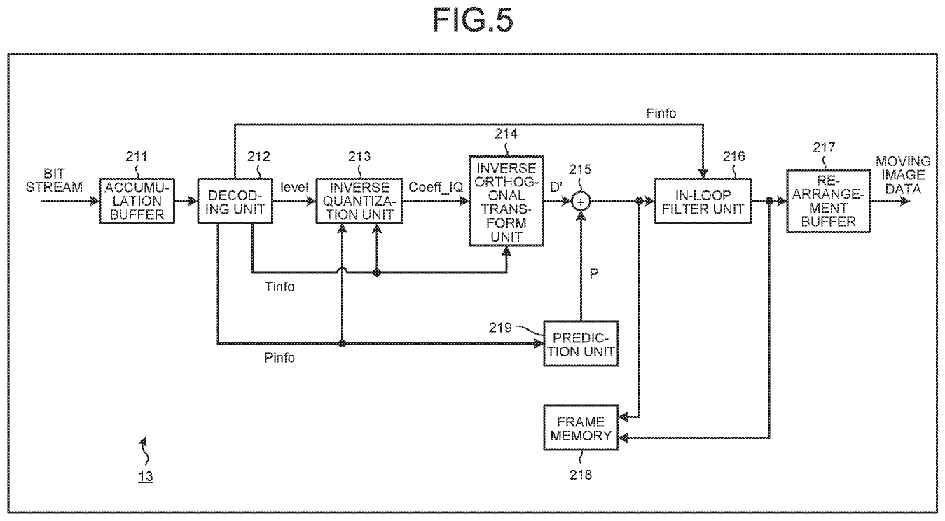

FIG. 5 is a block diagram illustrating a configuration example of an embodiment of the image decoding device according to the first embodiment of the present disclosure. The image decoding device 13 illustrated in FIG. 5 is a device such as advanced video codec (AVC) or high efficiency video coding (HEVC) that decodes coded data in which a prediction residual between an image and a prediction image of the image is coded. For example, the image decoding device 13 implements technologies described in Non Patent Literature 1, Non Patent Literature 2, or Non Patent Literature 3 and decodes coded data in which image data of a moving image is coded by a method conforming to a standard described in any one of those Non Patent Literatures. For example, the image decoding device 13 decodes the coded data (bit stream) generated by the image coding device 12 described above.

Note that FIG. 5 illustrates main portions such as processing units, data flows or the like, and those illustrated in FIG. 5 are not all. That is, in the image decoding device 13, there may be a processing unit that is not illustrated as a block in FIG. 5 or there may be processing or a data flow that is not illustrated as an arrow or the like in FIG. 5.

In FIG. 5, the image decoding device 13 is configured to include an accumulation buffer 211, a decoding unit 212, an inverse quantization unit 213, an inverse orthogonal transform unit 214, a calculation unit 215, an in-loop filter unit 216, a rearrangement buffer 217, a frame memory 218, and a prediction unit 219. Note that the prediction unit 219 includes an intra-prediction unit (not illustrated) and an inter-prediction unit (not illustrated). The image decoding device 13 is a device for generating moving image data by decoding the coded data (bit stream).

<Accumulation Buffer>

The accumulation buffer 211 acquires and holds (stores) the bit stream input to the image decoding device 13. The accumulation buffer 211 supplies the accumulated bit stream to the decoding unit 212 at a predetermined timing or in a case where a predetermined condition is satisfied.

<Decoding Unit>

The decoding unit 212 performs processing regarding decoding of the image. For example, the decoding unit 212 takes the bit stream supplied from the accumulation buffer 211 as an input and performs variable-length decoding of a syntax value of each syntax element from the bit string according to definition of a syntax table to derive a parameter.

The syntax element and the parameter derived from the syntax value of the syntax element include, for example, information such as header information Hinfo, prediction mode information Pinfo, transform information Tinfo, residual information Rinfo, filter information Finfo, and the like. That is, the decoding unit 212 parses (analyzes and acquires) these pieces of information from the bit stream. These information will be described below.

<Header Information Hinfo>

The header information Hinfo includes header information such as, for example, Video Parameter Set (VPS)/Sequence Parameter Set (SPS)/PicTUre Parameter Set (PPS)/slice header (SH), or the like. The header information Hinfo includes, for example, information defining an image size (a horizontal width PicWidth and a vertical width PicHeight), a bit depth (a luminance bitDepthY and a chrominance bitDepthC), a chrominance array type ChromaArrayType, a maximum value MaxCUSize/minimum value MinCUSize of a CU size, a maximum depth MaxQTDepth/minimum depth MinQTDepth of Quad-tree division, a maximum depth MaxBTDepth/minimum depth MinBTDepth of binary-tree division (Binary-tree division), a maximum value MaxTSSize (also referred to as a maximum transform skip block size) of a transform skip block, an on/off flag (also referred to as an enabled flag) of each coding tool, and the like.

For example, as the on/off flags of the coding tool included in the header information Hinfo there is an on/off flag related to transform and quantization processing shown below. Note that the on/off flag of the coding tool can also be interpreted as a flag indicating whether or not a syntax related to the coding tool exists in the coded data. In addition, in a case where a value of the on/off flag is 1 (true), it indicates that the coding tool can be used, and in a case where a value of the on/off flag is 0 (false), it indicates that the coding tool cannot be used. Note that the interpretation of the flag value may be reversed.

Cross-component prediction enabled flag (ccp_enabled_flag): It is flag information indicating whether or not cross-component prediction (CCP) (also referred to as CC prediction) is available. For example, in a case where this flag information is “1” (true), it indicates that the CCP is available, and in a case where it is “0” (false), it indicates that the CCP is not available.

Note that this CCP is also referred to as cross-component linear prediction (CCLM or CCLMP).

<Prediction Mode Information Pinfo>

The prediction mode information Pinfo includes, for example, information such as size information PBSize (prediction block size) of a processing target prediction block (PB), intra-prediction mode information IPinfo, and motion prediction information MVinfo, and the like.

The intra-prediction mode information IPinfo includes, for example, prev_intra_luma_pred_flag, mpm_idx and rem_intra_pred_mode in JCTVC-W1005, 7.3.8.5 Coding Unit syntax, a luminance intra-prediction mode IntraPredModeY derived from the syntax, and the like.

In addition, the intra-prediction mode information IPinfo includes, for example, a cross-component prediction flag (ccp_flag (cclmp_flag)), a multiclass linear prediction mode flag (mclm_flag), a chrominance sample location type identifier (chroma_sample_loc_type_idx), a chrominance MPM identifier (chroma_mpm_idx), and, a luminance intra-prediction mode (IntraPredModeC) derived from these syntaxes.

The cross-component prediction flag (ccp_flag (cclmp_flag)) is flag information indicating whether or not to apply cross-component linear prediction. For example, when ccp_flag==1, it indicates that the cross-component prediction is applied, and when ccp_flag==0, it indicates that the cross-component prediction is not applied.

The multiclass linear prediction mode flag (mclm_flag) is information regarding a mode of linear prediction (linear prediction mode information). More specifically, the multiclass linear prediction mode flag (mclm_flag) is flag information indicating whether or not to set a multiclass linear prediction mode. For example, in a case where this flag is “0”, it indicates that the mode of the linear prediction is in a one-class mode (single class mode) (for example, CCLMP), and in a case where this flag is “1”, it indicates that the mode of the linear prediction is in a two-class mode (multi-class mode) (for example, MCLMP).

The chrominance sample location type identifier (chroma_sample_loc_type_idx) is an identifier that identifies a type of pixel location (also referred to as a chrominance sample location type) of a chrominance component. For example, in a case where the chrominance array type (ChromaArrayType), which is information regarding a color format, indicates a 420 format, the chrominance sample location type identifier is allocated as follows.
chroma_sample_loc_type_idx==0: Type2
chroma_sample_loc_type_idx==1: Type3
chroma_sample_loc_type_idx==2: Type0
chroma_sample_loc_type_idx==3: Type1

Note that the chrominance sample location type identifier (chroma_sample_loc_type_idx) is (stored in and) transmitted as information (chroma_sample_loc_info ( )) regarding the pixel location of the chrominance component.

The chrominance MPM identifier (chroma_mpm_idx) is an identifier indicating which prediction mode candidate in a chrominance intra-prediction mode candidate list (intraPredModeCandListC) is designated as a chrominance intra-prediction mode.

The motion prediction information MVinfo includes information such as merge_idx, merge_flag, inter_pred_idc, ref_idx_LX, mvp_1X_flag, X=(0,1), mvd, and the like (see, for example, JCTVC-W1005, 7.3.8.6 Prediction Unit Syntax).

Of course, the information included in the prediction mode information Pinfo is arbitrary, and information other than these pieces of information may be included in the prediction mode information Pinfo.

<Transform Information Tinfo>

The transform information Tinfo includes, for example, the following information. Of course, information included in the transform information Tinfo is arbitrary, and information other than these pieces of information may be included in the transform information Tinfo.

A horizontal width size TBWSize and a vertical width TBHSize of a transform block to be processed (or each TBWSize having 2 as a base and logarithmic values log 2TBWSize and log 2TBHSize of the TBHSize).

Transform skip flag (ts_flag): It is a flag indicating whether or not to skip (reverse) primary transform and (reverse) secondary transform.

Scan identifier (scanIdx)

Quantization parameters (qp)

Quantization matrix (scaling_matrix (for example, JCTVC-W1005, 7.3.4 Scaling list data syntax))

<Residual Information Rinfo>

The residual information Rinfo (see, for example, 7.3.8.11 Residual Coding syntax in JCTVC-W1005) includes, for example, the following syntaxes.
cbf (coded block flag): Residual data presence/absence flag
last_sig_coeff_x_pos: Last nonzero coefficient X coordinate
last_sig_coeff_y_pos: Last nonzero coefficient Y coordinate coded sub block flag: Subblock nonzero coefficient presence/absence flag
sig_coeff_flag: Nonzero coefficient presence/absence flag
gr1_flag: Flag indicating whether or not level of nonzero coefficient is greater than 1 (also referred to as GR1 flag)
gr2_flag: Flag indicating whether or not level of nonzero coefficient is greater than 2 (also referred to as GR2 flag)
sign_flag: Sign indicating positive/negative of nonzero coefficient (also referred to as sign)
coeff_abs_level_remaining: Residual level of non-zero coefficient (also referred to as non-zero coefficient residual level) or the like.

Of course, information included in the residual information Rinfo is arbitrary, and information other than these pieces of information may be included in the residual information Rinfo.

<Filter Information Finfo>

The filter information Finfo includes, for example, control information regarding each filter processing shown in the following.
Control information regarding deblocking filter (DBF)
Control information regarding sample adaptive offset (SAO)
Control information regarding adaptive loop filter (ALF)
Control information regarding other linear and nonlinear filters

More specifically, for example, a picture to which each filter is applied, information for designating a region in the picture, filter on/off control information in units of the CU, a slice, filter on/off control information regarding a boundary of a title, or the like, is included in the filter information. Of course, information included in the filter information Finfo is arbitrary, and information other than these pieces of information may be included in the filter1 information Finfo.

Returning to a description of the decoding unit 212, the decoding unit 212 derives a quantization transform coefficient level level of each coefficient location in each transform block with reference to the residual information Rinfo. The decoding unit 212 supplies the quantization transform coefficient level level to the inverse quantization unit 213.

In addition, the decoding unit 212 supplies the parsed header information Hinfo, prediction mode information Pinfo, quantization transform coefficient level level, transform information Tinfo, and filter information Finfo to each block. Specifically, it is as follows.

The header information Hinfo is supplied to the inverse quantization unit 213, the inverse orthogonal transform unit 214, the prediction unit 219, and the in-loop filter unit 216.
The prediction mode information Pinfo is supplied to the inverse quantization unit 213 and the prediction unit 219.
The transform information Tinfo is supplied to the inverse quantization unit 213 and the inverse orthogonal transform unit 214.
The filter information Finfo is supplied to the in-loop filter unit 216.

Of course, the example described above is an example, and the present disclosure is not limited to this example. For example, each coding parameter may be supplied to an arbitrary processing unit. In addition, other information may be supplied to an arbitrary processing unit.

<Inverse Quantization Unit>

The inverse quantization unit 213 performs processing regarding inverse quantization. For example, the inverse quantization unit 213 takes the transform information Tinfo and the quantization transform coefficient level level supplied from the decoding unit 212 as inputs, and scales (inversely quantizes) a value of the quantization transform coefficient level level based on the transform information Tinfo to derive the transform coefficient Coeff_IQ after the inverse quantization.

Note that this inverse quantization is performed as inverse processing of the quantization by the quantization unit 114. In addition, this inverse quantization is processing similar to the inverse quantization by the inverse quantization unit 117. That is, the inverse quantization unit 117 performs processing (inverse quantization) similar to that of the inverse quantization unit 213.

The inverse quantization unit 213 supplies the derived transform coefficient Coeff_IQ to the inverse orthogonal transform unit 214.

<Inverse Orthogonal Transform Unit>

The inverse orthogonal transform unit 214 performs processing regarding inverse orthogonal transform. For example, the inverse orthogonal transform unit 214 takes the transform coefficient Coeff_IQ supplied from the inverse quantization unit 213 and the transform information Tinfo supplied from the decoding unit 212 as inputs, and performs the inverse orthogonal transform processing on the transform coefficient Coeff_IQ based on the transform information Tinfo to derive a prediction residual D′.

Note that this inverse orthogonal transform is performed as inverse processing of the orthogonal transform by the orthogonal transform unit 113. In addition, this inverse orthogonal transform is processing similar to the inverse orthogonal transform by the inverse orthogonal transform unit 118. That is, the inverse orthogonal transform unit 118 performs processing (inverse orthogonal transform) similar to that of the inverse orthogonal transform unit 214.

The inverse orthogonal transform unit 214 supplies the derived prediction residual D′ to the calculation unit 215.

<Calculation Unit>

The calculation unit 215 performs processing regarding addition of information regarding to the image. For example, the calculation unit 215 takes the prediction residual D′ supplied from the inverse orthogonal transform unit 214 and a prediction image P supplied from the prediction unit 219 as inputs. The calculation unit 215 adds the prediction residual D′ to the prediction image P (prediction signal) corresponding to the prediction residual D′ to derive a locally decoded image R_{local} (R_{local}=D′+P).

The calculation unit 215 supplies the derived locally decoded image R_{local} to the in-loop filter unit 216 and the frame memory 218.

<In-Loop Filter Unit>

The in-loop filter unit 216 performs processing regarding in-loop filter processing. For example, the in-loop filter unit 216 takes the locally decoded image R_{local} supplied from the calculation unit 215 and the filter information Finfo supplied from the decoding unit 212 as inputs. Note that the information input to the in-loop filter unit 216 is arbitrary, and information other than these pieces of information may be input to the in-loop filter unit 216.

The in-loop filter unit 216 performs appropriate filter processing on the locally decoded image R_{local} based on the filter information Finfo.

For example, the in-loop filter unit 216 applies four in-loop filters such as a bilateral filter, a deblocking filter (DBF), an adaptive offset filter (Sample Adaptive Offset (SAO)), and an adaptive loop filter (ALF) in this order, as described in Non Patent Literature 1. Note that which filter is applied and which order the filters are applied is arbitrary and can be appropriately selected.

The in-loop filter unit 216 performs filter processing corresponding to the filter processing performed by a coding side (for example, the in-loop filter unit 120 of the image coding device 12 in FIG. 4).

Of course, the filter processing performed by the in-loop filter unit 216 is arbitrary and is not limited to the example described above. For example, the in-loop filter unit 216 may apply a Wiener filter or the like.

The in-loop filter unit 216 supplies the filter-processed locally decoded image R_{local} to the rearrangement buffer 217 and the frame memory 218.

<Rearrangement Buffer>

The rearrangement buffer 217 takes the locally decoded image R_{local} supplied from the in-loop filter unit 216 as an input, and holds (stores) the locally decoded image R_{local}. The rearrangement buffer 217 reconstructs a decoded image R for each picture unit using the locally decoded image R_{local}, and holds the decoded image R (stores the decoded image R in a buffer). The rearrangement buffer 217 rearranges the obtained decoded images R from the decoding order to the reproduction order. The rearrangement buffer 217 outputs a group of the rearranged decoded images R as moving image data to the outside of the image decoding device 13.

<Frame Memory>

The frame memory 218 performs processing regarding storage of data regarding the image. For example, the frame memory 218 takes the locally decoded image R_{local} supplied from the calculation unit 215 as an input, reconstructs the decoded image R for each picture unit, and stores the decoded image R in a buffer in the frame memory 218.

In addition, the frame memory 218 takes the in-loop filter-processed locally decoded image R_{local} supplied from the in-loop filter unit 216 as an input, reconstructs the decoded image R for each picture unit, and stores the decoded image R in the buffer in the frame memory 218. The frame memory 218 appropriately supplies the stored decoded image R (or a part thereof) to the prediction unit 219 as a reference image.

Note that the frame memory 218 may store the header information Hinfo, the prediction mode information Pinfo, the transform information Tinfo, the filter information Finfo, and the like, related to generation of the decoded image.

<Prediction Unit>

The prediction unit 219 performs processing regarding generation of the prediction image P. For example, the prediction unit 219 takes the prediction mode information Pinfo supplied from the decoding unit 212 as an input and performs prediction by a prediction method designated by the prediction mode information Pinfo to derive a prediction image P. At the time of deriving the prediction image, the prediction unit 219 uses the decoded image R (or a part of the decoded image R) before or after the filter stored in the frame memory 218, designated by the prediction mode information Pinfo as a reference image. The prediction unit 219 supplies the derived prediction image P to the calculation unit 215.

Note that each processing performed as the orthogonal transform unit and the control unit in the decoding circuit 33 as described above with reference to FIG. 3 is not individually performed in each block illustrated in FIG. 5, and may be performed by, for example, a plurality of blocks.

[Image Coding Processing and Image Decoding Processing]

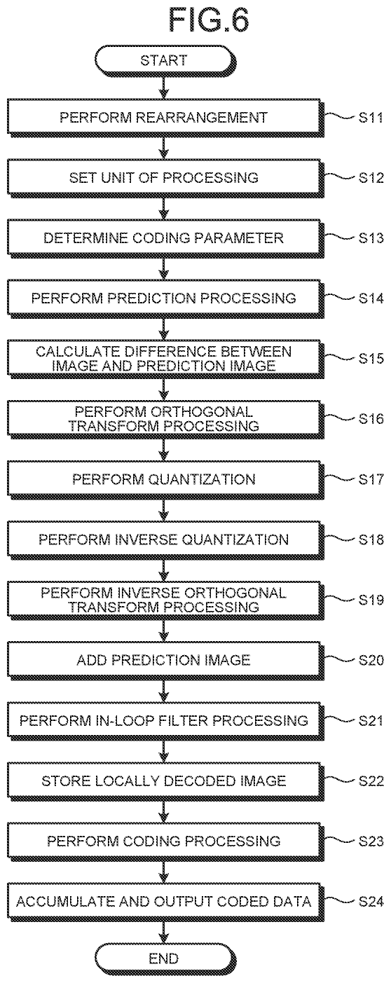

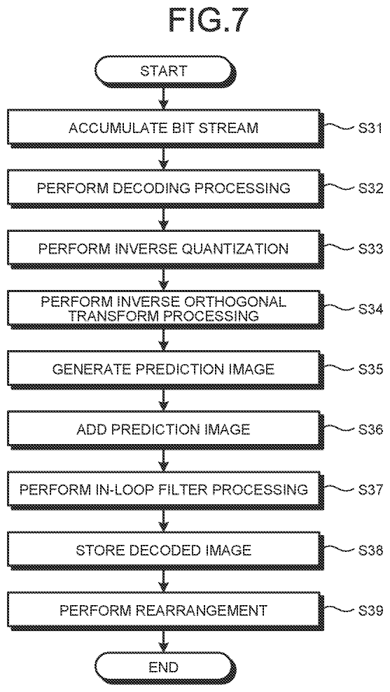

Image coding processing executed by the image coding device 12 and image decoding processing executed by the image decoding device 13 will be described with reference to flowcharts of FIGS. 6 and 7.

FIG. 6 is a flowchart for describing image coding processing executed by the image coding device 12 according to the first embodiment of the present disclosure.

When the image coding processing starts, the rearrangement buffer 111 is controlled by the control unit 101 to rearrange order of frames of input moving image data from the display order to the coding order (Step S11).

The control unit 101 sets a unit of processing (performs block division) for the input image held by the rearrangement buffer 111 (Step S12).

The control unit 101 determines (sets) the coding parameter for the input image held in the rearrangement buffer 111 (Step S13).

The prediction unit 122 performs prediction processing to generate a prediction image P or the like in an optimum prediction mode (Step S14). For example, in this prediction process, the prediction unit 122 performs intra-prediction to generate a prediction image P or the like in an optimum intra-prediction mode, performs inter-prediction to generate a prediction image P or the like in an optimum inter-prediction mode, and selects an optimum prediction mode from these prediction images based on a cost function value or the like.

The calculation unit 112 calculates a difference between the input image and the prediction image P in the optimum mode selected by the prediction processing in Step S14 (Step S15). That is, the calculation unit 112 generates the prediction residual D between the input image and the prediction image P. A data amount of the prediction residual D obtained as described above is reduced as compared with original image data. Therefore, the data amount can be compressed as compared with a case where the image is coded as it is.

The orthogonal transform unit 113 performs orthogonal transform processing on the prediction residual D generated by the processing in Step S15 to derive the transform coefficient Coeff (Step S16).

The quantization unit 114 quantizes the transform coefficient Coeff obtained by the processing in Step S16 using the quantization parameter calculated by the control unit 101 to derive the quantization transform coefficient level level (Step S17).

The inverse quantization unit 117 inversely quantizes the quantization transform coefficient level level generated by the processing in Step S17 with characteristics corresponding to quantization characteristics in Step S17 to derive the transform coefficient Coeff_IQ (Step S18).

The inverse orthogonal transform unit 118 performs the inverse orthogonal transform on the transform coefficient Coeff_IQ obtained by the processing in Step S18 by a method corresponding to the orthogonal transform processing in Step S16 to derive the prediction residual D′ (Step S19). Note that this inverse orthogonal transform processing is similar to inverse orthogonal transform processing (to be described later) performed on the decoding side, and a description (to be described later) provided for the decoding side can thus be applied to the inverse orthogonal transform processing in Step S19.

The calculation unit 119 generates the locally decoded image by adding the prediction image P obtained by the prediction processing in Step S14 to the prediction residual D′ derived by the processing in Step S19 (Step S20).

The in-loop filter unit 120 performs the in-loop filter processing on the locally decoded image derived by the processing in Step S20 (Step S21).

The frame memory 121 stores the locally decoded image derived by the processing in Step S20 or the locally decoded image filter-processed in Step S21 (Step S22).

The coding unit 115 codes the quantization transform coefficient level level obtained by the processing in Step S17 (Step S23). For example, the coding unit 115 codes the quantization transform coefficient level level, which is information regarding the image, by arithmetic coding or the like to generate coded data. In addition, at this time, the coding unit 115 codes various coding parameters (header information Hinfo, prediction mode information Pinfo, and transform information Tinfo). Further, the coding unit 115 derives the residual information RInfo from the quantization transform coefficient level level and codes the residual information RInfo.

The accumulation buffer 116 accumulates the coded data obtained in this way, and outputs the coded data as, for example, a bit stream to the outside of the image coding device (Step S24). This bit stream is transmitted to the decoding side via, for example, a transmission line or a recording medium. In addition, the rate control unit 123 performs rate control, if necessary.

When the processing in Step S24 ends, the image coding processing ends.

FIG. 7 is a flowchart for describing image decoding processing executed by the image decoding device 13 according to the first embodiment of the present disclosure.

When the image decoding processing starts, the accumulation buffer 211 acquires and holds (accumulates) the coded data (bit stream) supplied from the outside of the image decoding device 13 (Step S31).

The decoding unit 212 decodes the coded data (bit stream) to obtain the quantization transform coefficient level level (Step S32). In addition, the decoding unit 212 parses (analyzes and acquires) the various coding parameters from the coded data (bit stream) by this decoding.

The inverse quantization unit 213 performs inverse quantization, which is inverse processing of the quantization performed on the coding side, on the quantization transform coefficient level level obtained by the processing in Step S32, to obtain the transform coefficient Coeff_IQ (Step S33).

The inverse orthogonal transform unit 214 performs inverse orthogonal transform processing, which is inverse processing of the orthogonal transform processing performed on the coding side, on the transform coefficient Coeff_IQ obtained by the processing in Step S33 to obtain the prediction residual D′ (Step S34).

The prediction unit 219 executes prediction processing by the prediction method designated by the coding side based on the information parsed in Step S32, and refers to the reference image stored in the frame memory 218 to generate the prediction image P (Step S35).

The calculation unit 215 adds the prediction image P obtained by the processing in Step S35 to the prediction residual D′ obtained by the processing in Step S34 to derive the locally decoded image R_{local} (Step S36).

The in-loop filter unit 216 performs in-loop filter processing on the locally decoded image R_{local} obtained by the processing in Step S36 (Step S37).

The rearrangement buffer 217 derives the decoded image R using the filter-processed locally decoded image R_{local} obtained by the processing in Step S37, and rearranges the order of the group of the decoded images R from the decoding order to the reproduction order (Step S38). The group of the decoded images R rearranged in the reproduction order is output as a moving image to the outside of the image decoding device 13.

In addition, the frame memory 218 stores at least one of the locally decoded image R_{local} obtained by the processing in Step S36 and the filter-processed locally decoded image R_{local} obtained by the processing in Step S37 (Step S39).

When the processing in Step S39 ends, the image decoding processing ends.

[Outline of CU Block Division According to First Embodiment]

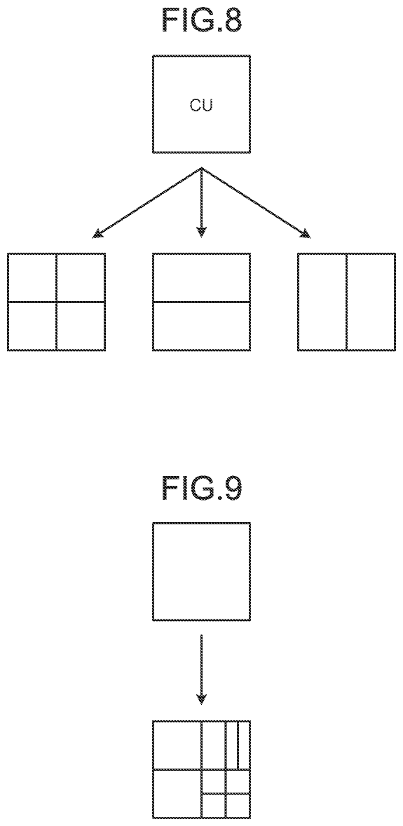

FIG. 8 is a diagram (1) illustrating an example of block division of a CU according to the first embodiment of the present disclosure. FIG. 9 is a diagram (2) illustrating an example of block division of a CU according to the first embodiment of the present disclosure. The control unit 101 divides the CU as illustrated in FIG. 8. Further, the control unit 101 can further divide the divided CU as illustrated in FIG. 9. As described above, as illustrated in FIGS. 8 and 9, even in a case of dividing the CU, the numbers of pixels in a height direction and a width direction of the CU are a power of 2.

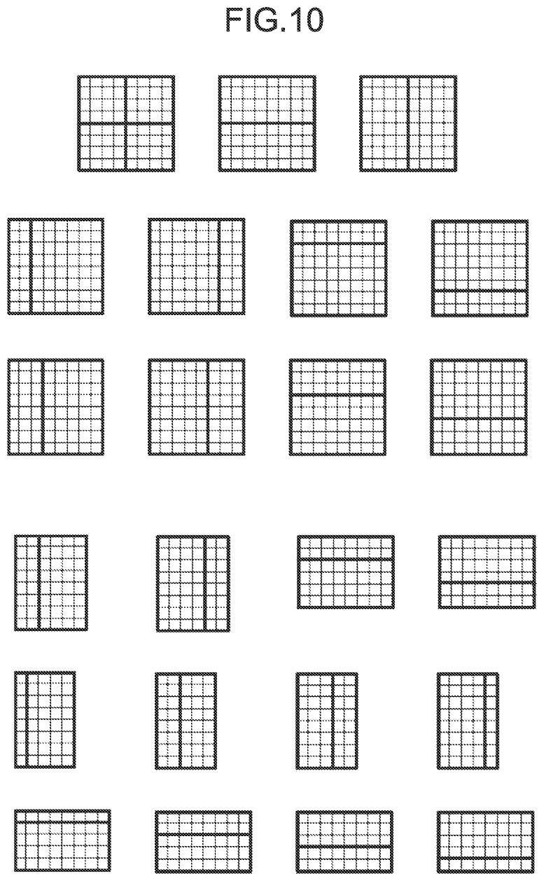

By the way, in motion compensation, it is preferable to divide a block at a boundary of motion, and block division with a high degree of freedom is thus desired. FIG. 10 is a diagram illustrating a variation of the block division of the CU according to the first embodiment of the present disclosure. As illustrated in FIG. 10, in a case where a variation of the block division of the CU is increased, the number of pixels in the height direction or the width direction of the CU may not be a power of 2.

Here, it is proposed that the CU has the same size as that of the TU. That is, a specification in which orthogonal transform or inverse orthogonal transform is executed in units of the CU has been proposed. Then, in a case where the block division as illustrated in FIG. 10 is executed, there is a CU in which the number of pixels in the width direction or the height direction is not the power of 2. For this reason, the orthogonal transform and the inverse orthogonal transform may have to be executed for the CU in which the number of pixels in the width direction or the height direction is not the power of 2, that is, a block in which the number of pixels in the width direction or the height direction is not the power of 2. In a case where the number of pixels in the width direction or the height direction is the power of 2, a calculation amount is reduced by the fast Fourier transform, so processing can be executed at a high speed with a small processing amount. However, in a case where the orthogonal transform or the inverse orthogonal transform is executed for the CU in which the number of pixels in the width direction or the height direction is not the power of 2, the fast Fourier transform cannot be used, so a processing amount increases, such that it becomes difficult to improve a processing speed. Therefore, in a case where the number of pixels of the CU is not the power of 2, quantization, inverse quantization, orthogonal transform, and inverse orthogonal transform are executed by the following method.

[Coding Processing of Image Coding Device 12 According to First Embodiment]

Here, FIG. 11 is a diagram illustrating an example before and after division of the CU according to the first embodiment of the present disclosure. FIG. 11(a) is a diagram illustrating an example of the CU before being divided. FIG. 11(b) is a diagram illustrating an example of the divided CU. In FIG. 11(b), the number of pixels in the width direction of a right region is not the power of 2 by dividing the CU at a boundary. For this reason, in a case where the orthogonal transform is executed for the right region illustrated in FIG. 11(b), a processing amount increases, such that it becomes difficult to improve a processing speed. Therefore, in the right region illustrated in FIG. 11(b), the orthogonal transform is skipped and quantization is executed.

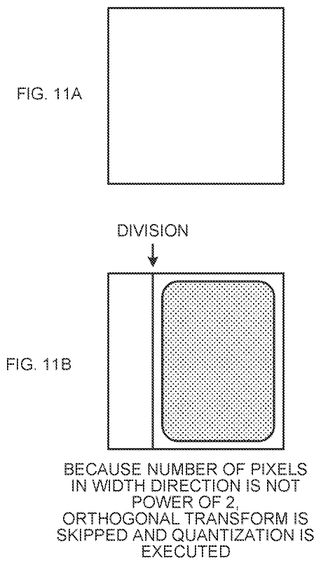

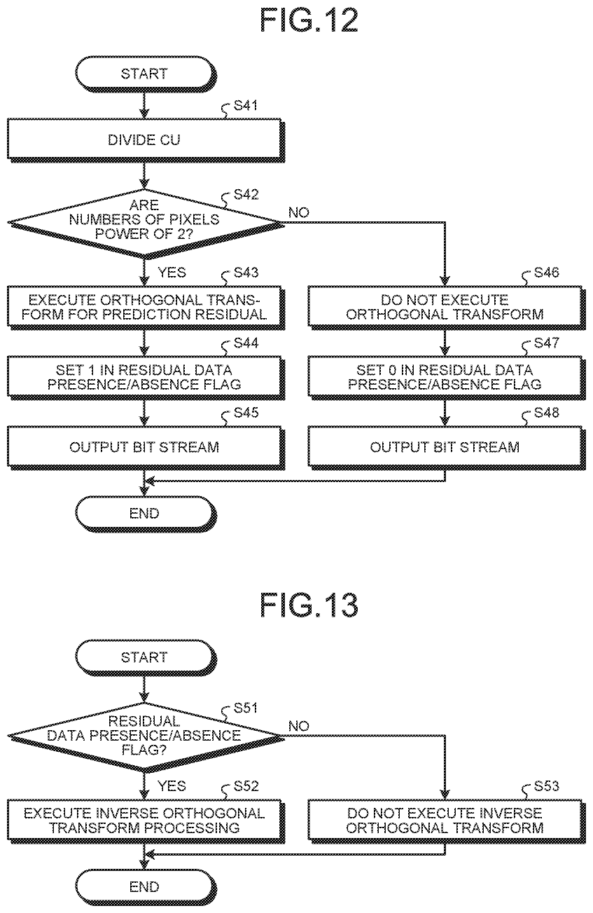

Here, FIG. 12 is a flowchart illustrating an example of coding processing according to the first embodiment of the present disclosure. The control unit 101 divides the CU along a boundary of motion (Step S41). The control unit 101 determines whether or not the numbers of pixels in the height direction and the width direction of the CU to be processed after being divided are the power of 2 (Step S42).

In a case where the numbers of pixels in the height direction and the width direction of the CU are the power of 2 (Step S42: Yes), the orthogonal transform unit 113 executes orthogonal transform for the prediction residual D (Step S43).

In addition, the control unit 101 sets 1 in the residual data presence/absence flag (cbf) indicating whether or not the prediction residual D is included (Step S44). That is, the control unit 101 sets that the prediction residual D is included, in the residual data presence/absence flag (cbf).

Then, the accumulation buffer 116 outputs a bit stream including the prediction residual D and the residual data presence/absence flag (cbf) (Step S45).

In Step S42, in a case where the number of pixels in either the height direction or the width direction of the CU is not the power of 2 (Step S42: No), the control unit 101 skips the orthogonal transform with respect to the prediction residual D by processing such as transform skip, a pulse code modulation (PCM) mode or the like and does not execute the orthogonal transform (Step S46).

In addition, the orthogonal transform unit 113 sets 0 indicating that the prediction residual D is not included, in the residual data presence/absence flag (cbf) (Step S47).

Then, the accumulation buffer 116 outputs a bit stream including the prediction image P for which the orthogonal transform is not executed and the residual data presence/absence flag (cbf) indicating that an orthogonally transformed prediction residual D is not included (Step S48).

As described above, in a case where the number of pixels in either the height direction or the width direction of the CU is not the power of 2, the image coding device 12 can suppress that a processing amount increases by not executing the orthogonal transform.

[Decoding Processing of Image Decoding Device 13 According to First Embodiment]

Next, processing in a decoder that decodes the bit stream output from the image coding device 12 will be described.

Here, FIG. 13 is a flowchart illustrating an example of decoding processing according to the first embodiment of the present disclosure. The decoding unit 212 determines whether or not the prediction residual D is included in the bit stream, based on the residual data presence/absence flag (cbf) included in the bit stream output by the image coding device 12 (Step S51).

In a case where the prediction residual D is included in the bit stream (Step S51: Yes), the decoding unit 212 causes the inverse orthogonal transform unit 214 to execute the inverse orthogonal transform for the prediction residual D included in the bit stream (Step S52).

On the other hand, in a case where the prediction residual D is not included in the bit stream (Step S51: No), the decoding unit 212 does not cause the inverse orthogonal transform unit 214 to execute the inverse orthogonal transform for the prediction image P included in the bit stream (Step S53).

As described above, in a case where the number of pixels in either the height direction or the width direction of the CU is not the power of 2, the image coding device 12 can suppress that a processing amount increases by not executing the orthogonal transform.

### First Modification of First Embodiment

In the first embodiment described above, the execution of the orthogonal transform and the inverse orthogonal transform has been controlled depending on whether or not the numbers of pixels in the height direction and the width direction of the CU to be processed after being divided is the power of 2. In the first modification, a prediction mode is further controlled.

The prediction mode includes inter-prediction that generates a prediction image based on an image different from a frame image to be processed and intra-prediction that generates a prediction image based on a frame image to be processed. In the intra-prediction, an amount of prediction residual D is large and orthogonal transform should be executed in many cases. In addition, in the inter-prediction, a high-definition image can be acquired as compared with the intra-prediction. Therefore, in a case where the numbers of pixels in the height direction and the width direction of the CU to be processed after being divided are not the power of 2, the prediction mode is fixed to the inter-prediction.

[Coding Processing of Image Coding Device 12 According to First Modification of First Embodiment]

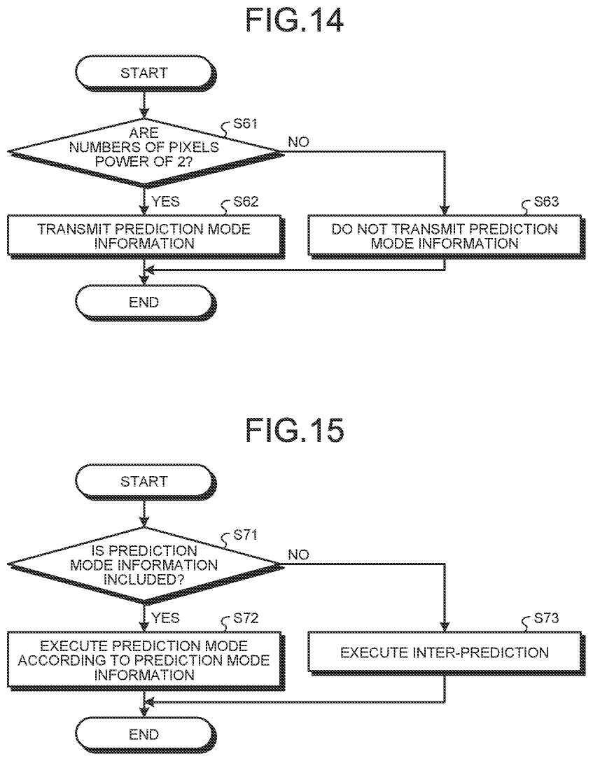

Here, FIG. 14 is a flowchart illustrating an example of coding processing according to a first modification of the first embodiment of the present disclosure. The control unit 101 determines whether or not the numbers of pixels in the height direction and the width direction of the CU to be processed after being divided are a power of 2 (Step S61).

In a case where the number of pixels in either the height direction or the width direction of the CU is not the power of 2 (Step S61: Yes), the prediction unit 122 executes the intra-prediction or the inter-prediction according to the image, and generates prediction mode information Pinfo indicating the executed prediction mode (Step S62). Here, the prediction mode information Pinfo includes mode information (pred_mode_flag) indicating which of the intra-prediction or the inter-prediction is executed. Then, the accumulation buffer 116 outputs a bit stream including the prediction mode information Pinfo.

On the other hand, in a case where the number of pixels in either the height direction or the width direction of the CU is not the power of 2 (Step S61: No), the prediction unit 122 executes the inter-prediction and does not generate the prediction mode information Pinfo (Step S63).

As a result, the accumulation buffer 116 outputs a bit stream that does not include the prediction mode information Pinfo. Therefore, the image coding device 12 can reduce a code amount.

[Decoding Processing of Image Decoding Device 13 According to First Modification of First Embodiment]

Here, FIG. 15 is a flowchart illustrating an example of decoding processing according to the first modification of the first embodiment of the present disclosure. The decoding unit 212 determines whether or not the received bit stream includes the prediction mode information Pinfo (Step S71).

In a case where the bit stream includes the prediction mode information Pinfo (Step S71: Yes), the prediction unit 122 executes intra-prediction or inter-prediction according to the prediction mode information Pinfo (Step S72).

On the other hand, when the bit stream does not include the prediction mode information Pinfo (Step S71: No), the prediction unit 122 executes inter-prediction (Step S73).

### Second Modification of First Embodiment

In the first embodiment described above, the execution of the orthogonal transform and the inverse orthogonal transform has been controlled depending on whether or not the numbers of pixels in the height direction and the width direction of the CU to be processed after being divided is the power of 2. Here, the reason why the orthogonal transform is not executed in a case where the number of pixels of the CU is not the power of 2 is that a processing amount of the orthogonal transform increases, such that a processing speed decreases. In a case where a size of the CU is smaller than a threshold value, it is considered that an influence on the processing speed is small even though the processing amount of the orthogonal transform increases. Therefore, even though the numbers of pixels in the height direction and the width direction of the CU to be processed after being divided is not the power of 2, the orthogonal transform may be executed.

[Coding Processing of Image Coding Device 12 According to Second Modification of First Embodiment]

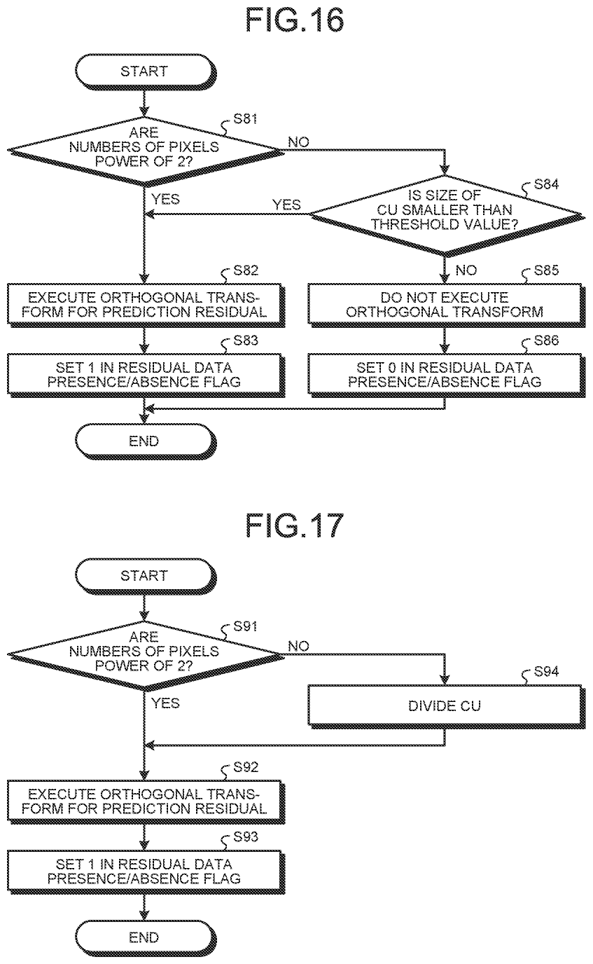

Here, FIG. 16 is a flowchart illustrating an example of coding processing according to a second modification of the first embodiment of the present disclosure. The control unit 101 determines whether or not the numbers of pixels in the height direction and the width direction of the CU to be processed after being divided are a power of 2 (Step S81).

In a case where the numbers of pixels in the height direction and the width direction of the CU are the power of 2 (Step S81: Yes), the orthogonal transform unit 113 executes orthogonal transform for the prediction residual D (Step S82).

In addition, the orthogonal transform unit 113 sets 1 in the residual data presence/absence flag (cbf) indicating whether or not the prediction residual D is included (Step S83). That is, the orthogonal transform unit 113 sets that the prediction residual D is included, in the residual data presence/absence flag (cbf).

In a case where the number of pixels in either the height direction or the width direction of the CU is not the power of 2 in Step S81 (Step S81: No), the control unit 101 determines whether or not a size of the CU is smaller than a threshold value (Step S84).

In a case where the size of the CU is smaller than the threshold value (Step S84; Yes), the orthogonal transform unit 113 executes the orthogonal transform for the prediction residual D in Step S82.

On the other hand, in a case where the size of the CU is equal to or larger than the threshold value (Step S84: Yes), the control unit 101 does not cause the orthogonal transform unit 113 to execute the orthogonal transform by processing such as transform skip, a PCM mode or the like (Step S85).

In addition, the orthogonal transform unit 113 sets 0 indicating that the prediction residual D is not included, in the residual data presence/absence flag (cbf) (Step S86).

As described above, the image coding device 12 executes the orthogonal transform in a case where the size of the CU is smaller than the threshold value, and does not execute the orthogonal transform in a case where the size of the CU is larger than the threshold value. Therefore, the image coding device 12 can suppress that a processing amount increases.

[Decoding Processing of Image Decoding Device 13 According to Second Modification of First Embodiment]

The image decoding device 13 executes processing similar to that of a flowchart illustrated in FIG. 13. That is, the image decoding device 13 executes inverse orthogonal transform processing based on the residual data presence/absence flag (cbf).

### Second Embodiment

In the first embodiment described above, the execution of the orthogonal transform and the inverse orthogonal transform has been controlled depending on whether or not the numbers of pixels in the height direction and the width direction of the CU to be processed after being divided is the power of 2. In a second embodiment, in a case where the numbers of pixels in a height direction and a width direction of a CU to be processed after being divided is not a power of 2, the CU is divided so as to form a CU in which the numbers of pixels in the height direction and the width direction are the power of 2. By dividing the CU as described above, the number of pixels of the CU, which was not the power of 2, is changed to the power of 2.

[Coding Processing of Image Coding Device 12 According to Second Embodiment]

Here, FIG. 17 is a flowchart illustrating an example of coding processing according to the second embodiment of the present disclosure. The control unit 101 determines whether or not the numbers of pixels in the height direction and the width direction of the CU to be processed after being divided are the power of 2 (Step S91).

In a case where the numbers of pixels in the height direction and the width direction of the CU are the power of 2 (Step S91: Yes), the orthogonal transform unit 113 executes orthogonal transform for the prediction residual D (Step S92).

In addition, the orthogonal transform unit 113 sets 1 in the residual data presence/absence flag (cbf) indicating whether or not the prediction residual D is included (Step S93). That is, the orthogonal transform unit 113 sets that the prediction residual D is included, in the residual data presence/absence flag (cbf).

In a case where the number of pixels in either the height direction or the width direction of the CU is not the power of 2 in Step S91 (Step S91: No), the control unit 101 further divides a CU in which the number of pixels in either the height direction or the width direction is not the power of 2 (Step S94). At this time, the control unit 101 divides the CU so as to form a CU in which the numbers of pixels in the height direction and the width direction are the power of 2. Then, the processing proceeds to Step S92.

The proceeding to Step S92 is an example, and the process may proceed to Step S91. That is, even after the CU is divided, it is determined whether or not the number of pixels in either the height direction or the width direction of the CU is the power of 2, and in a case where the number of pixels in either the height direction or the width direction of the CU is not a power of 2, the CU may be divided again.

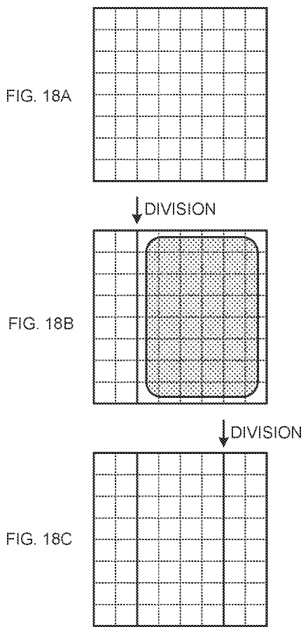

Aspects of dividing the CU will be exemplified and described with reference to FIGS. 18 to 20. Here, FIG. 18 is a diagram illustrating an example of a division aspect of the CU according to the second embodiment of the present disclosure. FIG. 18(a) illustrates the CU before being divided. FIG. 18(b) illustrates the CU after being first divided. FIG. 18(c) illustrates the CU after being second divided.

Due to the first division of the CU illustrated in FIG. 18(b), the number of pixels in the width direction of the CU on a right side of a boundary at which the CU is divided is no longer the power of 2. Therefore, the second division of the CU illustrated in FIG. 18(c) is executed. By dividing the CU symmetrically in a horizontal direction as described above, the number of pixels in the width direction of the CU becomes the power of 2.

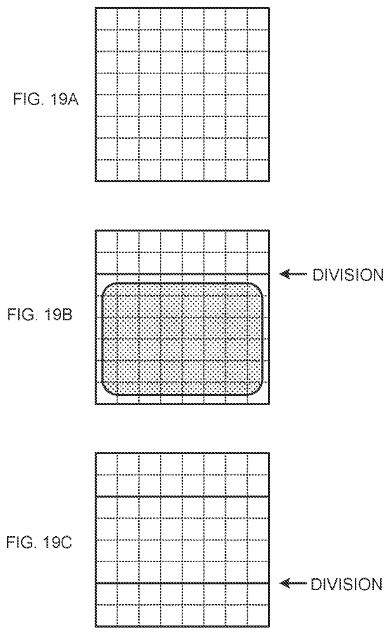

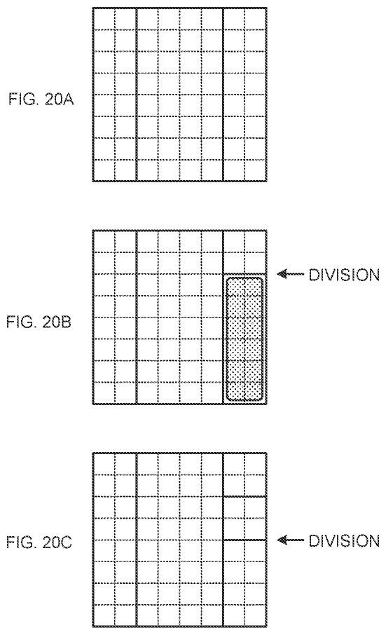

FIG. 19 is a diagram illustrating an example of a division aspect of the CU according to the second embodiment of the present disclosure. FIG. 19(a) illustrates the CU before being divided. FIG. 19(b) illustrates the CU after being first divided. FIG. 19(c) illustrates the CU after being second divided.

Due to the first division of the CU illustrated in FIG. 19(b), the number of pixels in the height direction of the CU on a lower side of a boundary at which the CU is divided is no longer the power of 2. Therefore, the second division of the CU illustrated in FIG. 19(c) is executed. By dividing the CU symmetrically in a vertical direction as described above, the number of pixels in the height direction of the CU becomes the power of 2.

FIG. 20 is a diagram illustrating an example of a division aspect of the CU according to the second embodiment of the present disclosure. FIG. 20(a) illustrates the CU after being divided. FIG. 20(b) illustrates a state in which the CU illustrated in FIG. 20(a) is divided. FIG. 20(c) illustrates a state in which the CU illustrated in FIG. 20(b) is divided.

Due to the first division of the CU illustrated in FIG. 20(b), the number of pixels in the height direction of the CU on a lower side of a boundary at which the CU is divided is no longer the power of 2. Therefore, the second division of the CU illustrated in FIG. 20(c) is executed. The CU is not limited to being divided symmetrically in the vertical direction or symmetrically in the horizontal direction as described above, and may also be divided so as to be asymmetric.

[Decoding Processing of Image Decoding Device 13 According to Second Embodiment]

In the second embodiment, the image coding device 12 divides the CU so that the numbers of pixels in the height direction and the width direction of the CU are the power of 2, and executes orthogonal transform. Therefore, the image decoding device 13 executes inverse orthogonal transform for each block.

### Third Embodiment

In the first embodiment described above, the execution of the orthogonal transform and the inverse orthogonal transform has been controlled depending on whether or not the numbers of pixels in the height direction and the width direction of the CU to be processed after being divided is the power of 2. In a third embodiment, orthogonal transform and inverse orthogonal transform are executed in a direction in which the number of pixels is a power of 2.

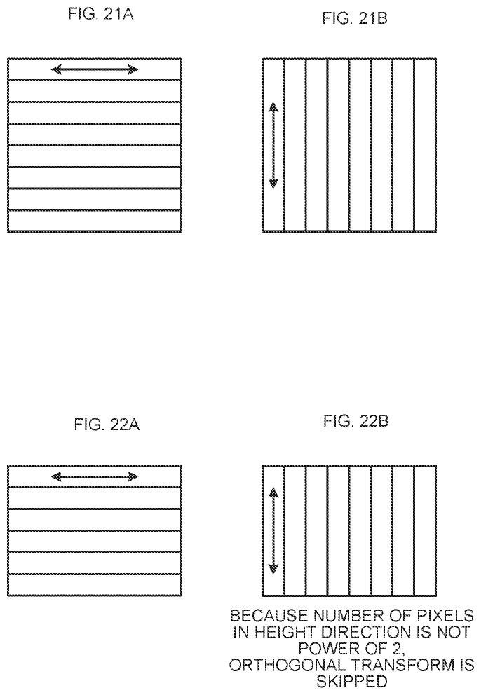

First, a case where the numbers of pixels in both of a height direction and a width direction of a CU are a power of 2 will be described. Here, FIG. 21 is a diagram illustrating a processing procedure of orthogonal transform for a CU in which the numbers of pixels in a height direction and a width direction according to the third embodiment of the present disclosure are a power of 2. FIG. 21(a) is a diagram illustrating that orthogonal transform is executed for each line in the width direction. FIG. 21(b) is a diagram illustrating that orthogonal transform is executed for each line in the height direction.

The orthogonal transform unit 113 executes the orthogonal transform for each line in the width direction, as illustrated in FIG. 21(a). Next, the orthogonal transform unit 113 executes the orthogonal transform for each line in the height direction with respect to coefficients after the orthogonal transform is executed, as illustrated in FIG. 21(b). Note that the orthogonal transform may be first executed in the height direction and be then executed in the width direction. Then, even though the orthogonal transform is first executed in any of the width direction and the height direction, theoretically the same result can be obtained. However, when rounding processing is executed with calculation accuracy in the middle, an error occurs if the order of directions in which the orthogonal transform is executed is changed. Therefore, it is preferable to define which direction to execute first and execute the orthogonal transform in the defined order.

In a case of inverse orthogonal transform, orthogonal transform is executed in reverse order. That is, in a case where the orthogonal transform is first executed in the width direction, the inverse orthogonal transform is first executed in the height direction. Next, the inverse orthogonal transform is executed in the width direction.

[Coding Processing of Image Coding Device 12 According to Third Embodiment]

Here, FIG. 22 is a diagram illustrating a CU in which the number of pixels in the height direction according to the third embodiment of the present disclosure is not the power of 2. FIG. 22(a) illustrates that the orthogonal transform is executed because the number of pixels in the width direction is the power of 2. FIG. 22(b) illustrates that the orthogonal transform is not executed because the number of pixels in the height direction is not the power of 2. Then, as illustrated in FIG. 22, in a case where the number of pixels in the height direction is not the power of 2, because the number of pixels in the width direction is the power of 2, the orthogonal transform in the width direction is executed, and the orthogonal transform in the height direction is skipped and is not executed.

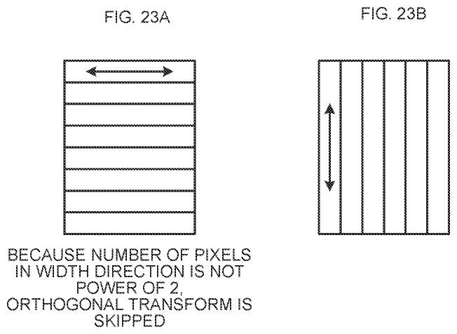

Here, FIG. 23 is a diagram illustrating a CU in which the number of pixels in the width direction according to the third embodiment of the present disclosure is not the power of 2. FIG. 23(a) illustrates that the orthogonal transform is not executed because the number of pixels in the width direction is not the power of 2. FIG. 23(b) illustrates that the orthogonal transform is executed because the number of pixels in the height direction is the power of 2. Then, as illustrated in FIG. 23, in a case where the number of pixels in the width direction is not the power of 2, it is illustrated that the orthogonal transform in the width direction is skipped and is not executed and the orthogonal transform in the height direction is executed because the number of pixels in the height direction is the power of 2.

[Decoding Processing of Image Decoding Device 13 According to Third Embodiment]

In a case of the CU in which the number of pixels in the height direction illustrated in FIG. 22 is not the power of 2, inverse orthogonal transform is executed in the width direction. On the other hand, the inverse orthogonal transform is not executed in the height direction. In addition, in a case of the CU in which the number of pixels in the width direction illustrated in FIG. 23 is not the power of 2, inverse orthogonal transform is not executed in the width direction. On the other hand, the inverse orthogonal transform is executed in the height direction. As described above, the image coding device 12 and the image decoding device 13 do not execute the orthogonal transform in the direction in which the number of pixels is the power of 2, and can thus suppress a significant increase in a processing amount.

### Fourth Embodiment

In the first embodiment described above, the execution of the orthogonal transform and the inverse orthogonal transform has been controlled depending on whether or not the numbers of pixels in the height direction and the width direction of the CU to be processed after being divided is the power of 2. In a fourth embodiment, orthogonal transform is executed for a maximum region in which the numbers of pixels in a height direction and a width direction are a power of 2 inside a CU in which the number of pixels in either the height direction or the width direction is not the power of 2. Then, the orthogonal transform is not executed in the remaining region except the maximum region. In addition, a rate distortion (RD) cost when the orthogonal transform is executed is calculated for each region where the orthogonal transform is executed. In addition, the RD cost is compared for each region. As a result, it becomes possible to determine an optimum region based on the RD cost.

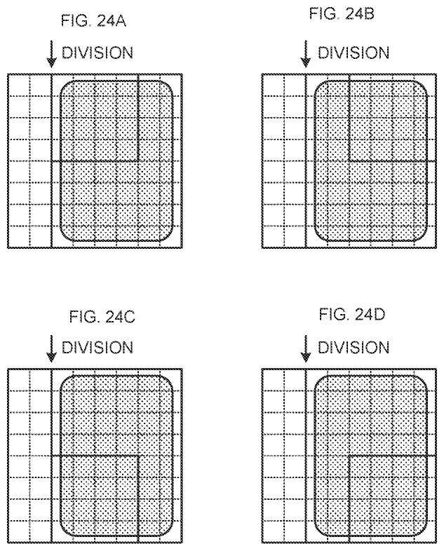

Here, FIG. 24 is a diagram illustrating an example of a variation of a region in which orthogonal transform is executed according to the fourth embodiment of the present disclosure. In FIG. 24, in a case where the CU is divided, the numbers of pixels in the width direction of a right region is no longer the power of 2. Therefore, it is illustrated that the orthogonal transform is executed for a maximum region where the number of pixels is the power of 2 and the numbers of pixels in the height direction and the width direction are the same as each other, in the right region. That is, it is illustrated that the orthogonal transform is executed for a square maximum region in which the number of pixels is the power of 2, in the right region. FIG. 24(a) illustrates that the orthogonal transform is executed in a left upper square region of the right region. FIG. 24(b) illustrates that the orthogonal transform is executed in a right upper square region of the right region. FIG. 24(c) illustrates that the orthogonal transform is executed in a left lower square region of the right region. FIG. 24(d) illustrates that the orthogonal transform is executed in a right lower square region of the right region.

[Coding Processing of Image Coding Device 12 According to Fourth Embodiment]

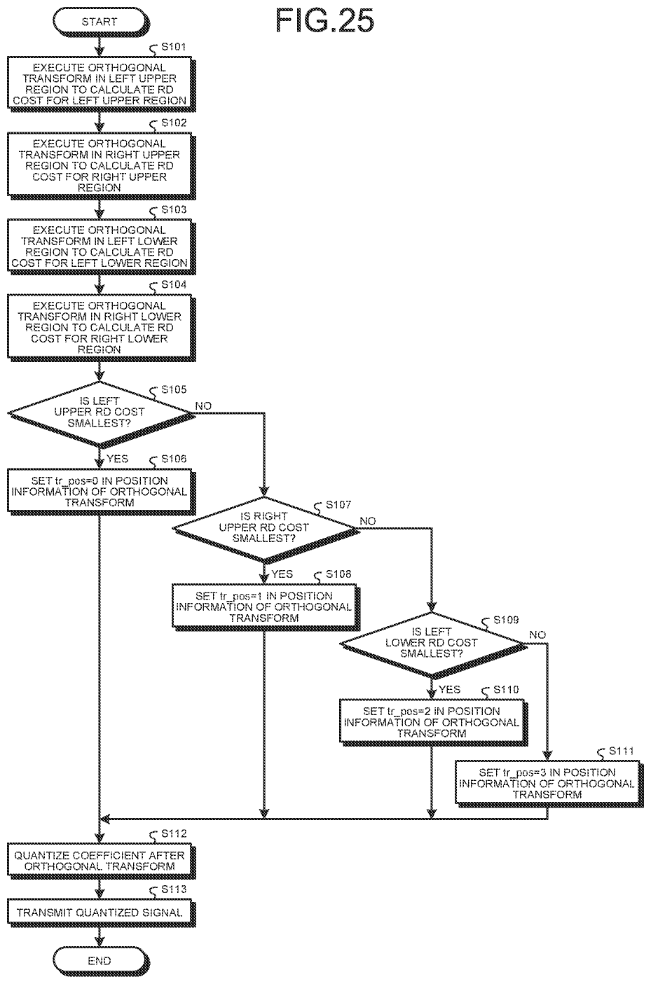

Here, FIG. 25 is a flowchart illustrating an example of coding processing according to the fourth embodiment of the present disclosure. Then, the coding processing illustrated in FIG. 25 shows that the orthogonal transform is executed for each region illustrated in FIG. 24 to calculate the RD cost.

The control unit 101 causes the orthogonal transform unit 113 to execute orthogonal transform in the left upper region illustrated in FIG. 24(a) to calculate a RD cost for the left upper region (Step S101). Note that the control unit 101 does not cause the orthogonal transform unit 113 to execute orthogonal transform in the remaining region except a maximum region.

The control unit 101 causes the orthogonal transform unit 113 to execute orthogonal transform in the right upper region illustrated in FIG. 24(b) to calculate a RD cost for the right upper region (Step S102). Note that the control unit 101 does not cause the orthogonal transform unit 113 to execute orthogonal transform in the remaining region except a maximum region.

The control unit 101 causes the orthogonal transform unit 113 to execute orthogonal transform in the left lower region illustrated in FIG. 24(c) to calculate a RD cost for the left lower region (Step S103). Note that the control unit 101 does not cause the orthogonal transform unit 113 to execute orthogonal transform in the remaining region except a maximum region.

The control unit 101 causes the orthogonal transform unit 113 to execute orthogonal transform in the right lower region illustrated in FIG. 24(d) to calculate a RD cost for the right lower region (Step S104). Note that the control unit 101 does not cause the orthogonal transform unit 113 to execute orthogonal transform in the remaining region except a maximum region.

It is determined whether or not the left upper RD cost of the RD costs calculated in Step S101 to Step S104 is the smallest (Step S105). In a case where the left upper RD cost is the smallest (Step S105: Yes), the control unit 101 sets tr_pos=0 in position information indicating a position of the orthogonal transform (Step S106). That is, the control unit 101 sets that the orthogonal transform has been executed in the left upper region, in the position information.

In a case where the left upper RD cost is not the smallest (Step S105: No), it is determined whether or not the right upper RD cost of the RD costs calculated in Step S101 to Step S104 is the smallest (Step S107).

In a case where the right upper RD cost is the smallest (Step S107: Yes), the control unit 101 sets tr_pos=1 in the position information indicating the position of the orthogonal transform (Step S108). That is, the control unit 101 sets that the orthogonal transform has been executed in the right upper region, in the position information.

In a case where the right upper RD cost is not the smallest (Step S107: No), it is determined whether or not the left lower RD cost of the RD costs calculated in Step S101 to Step S104 is the smallest (Step S109).

In a case where the left lower RD cost is the smallest (Step S109: Yes), the control unit 101 sets tr_pos=2 in the position information indicating the position of the orthogonal transform (Step S110). That is, the control unit 101 sets that the orthogonal transform has been executed in the left lower region, in the position information.

In a case where the right lower RD cost is not the smallest (Step S109: No), the control unit 101 sets tr_pos=3 in the position information indicating the position of the orthogonal transform (Step S111). That is, the control unit 101 sets that the orthogonal transform has been executed in the right lower region, in the position information.

The quantization unit 114 quantizes a coefficient after the orthogonal transform (Step S112).

The accumulation buffer 116 outputs a bit stream including a quantized signal and the position information indicating the position of the orthogonal transform (Step S113).

[Decoding Processing of Image Decoding Device 13 According to Fourth Embodiment]

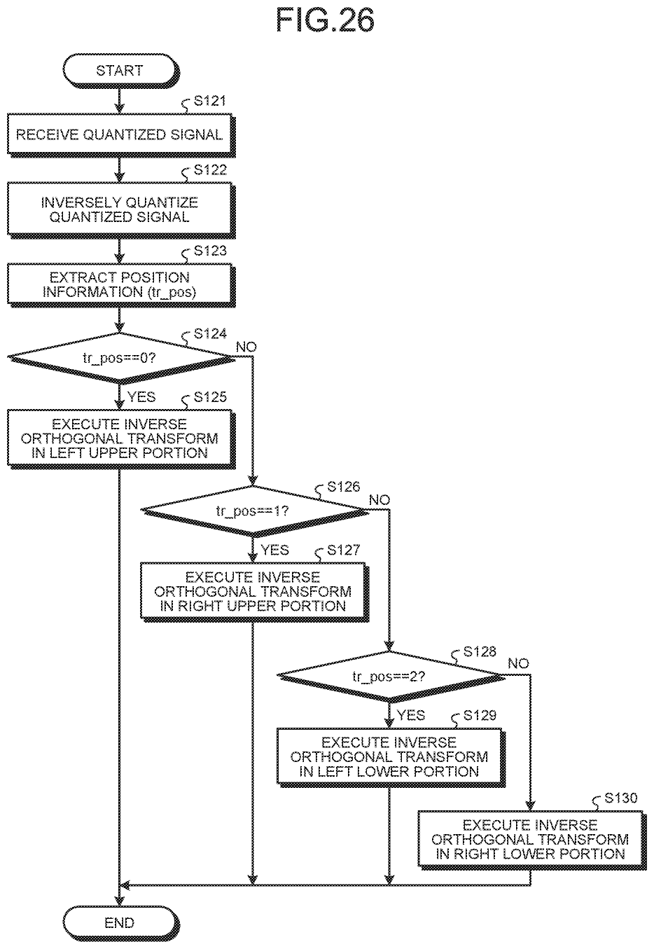

Here, FIG. 26 is a flowchart illustrating an example of decoding processing according to the fourth embodiment of the present disclosure. Then, in the decoding processing illustrated in FIG. 26, inverse orthogonal transform is executed for the orthogonally transformed region based on the position information indicating the position of the orthogonal transform.

The accumulation buffer 211 receives the quantized signal and the bit stream including the position information (tr_pos) indicating the position of the orthogonal transform (Step S121).

The inverse quantization unit 213 inversely quantizes the quantized signal (Step S122).

The decoding unit 212 extracts the position information (tr_pos) indicating the position where the orthogonal transform is executed from the bit stream (Step S123).

The decoding unit 212 determines whether or not the position information (tr_pos) indicates that the orthogonal transform has been executed at the left upper portion (Step S124). That is, the decoding unit 212 determines whether or not tr_pos==0.

In a case where the position information (tr_pos) indicates that the orthogonal transform has been executed at the left upper portion (Step S124: Yes), the decoding unit 212 causes the inverse orthogonal transform unit 214 to execute the inverse orthogonal transform for the left upper region illustrated in FIG. 24(a) (Step S125).

In a case where the position information (tr_pos) does not indicate that the orthogonal transform has been executed at the left upper portion (Step S124: No), the decoding unit 212 determines whether or not the position information (tr_pos) indicates that the orthogonal transform has been executed in the right upper portion (Step S126). That is, the decoding unit 212 determines whether or not tr_pos==1.

In a case where the position information (tr_pos) indicates that the orthogonal transform has been executed at the right upper portion (Step S126: Yes), the decoding unit 212 causes the inverse orthogonal transform unit 214 to execute the inverse orthogonal transform for the right upper region illustrated in FIG. 24(b) (Step S127).

In a case where the position information (tr_pos) does not indicate that the orthogonal transform has been executed at the right upper portion (Step S126: No), the decoding unit 212 determines whether or not the position information (tr_pos) indicates that the orthogonal transform has been executed in the left lower portion (Step S128). That is, the decoding unit 212 determines whether or not tr_pos==2.

In a case where the position information (tr_pos) indicates that the orthogonal transform has been executed at the left lower portion (Step S128: Yes), the decoding unit 212 causes the inverse orthogonal transform unit 214 to execute the inverse orthogonal transform for the left lower region illustrated in FIG. 24(c) (Step S129).

In a case where the position information (tr_pos) does not indicate that the orthogonal transform has been executed at the left lower portion (Step S128: No), the decoding unit 212 causes the inverse orthogonal transform unit 214 to execute the inverse orthogonal transform for the right lower region illustrated in FIG. 24(d) (Step S130).

Note that in the calculation of the RD cost, the orthogonal transform has been executed for a square maximum region in which the number of pixels is a power of 2. However, the region for which the orthogonal transform is executed is not limited to the square region, and may be a rectangular region.

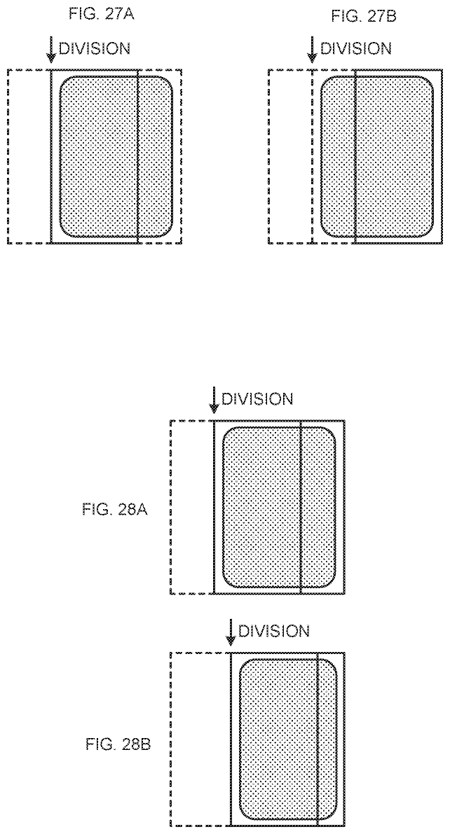

Here, FIG. 27 is a diagram illustrating an example of a variation of a region in which orthogonal transform is executed according to the fourth embodiment of the present disclosure. FIG. 27(a) illustrates that the orthogonal transform is executed in a left upper rectangular region of a right region. FIG. 27(b) illustrates that the orthogonal transform is executed in a right upper rectangular region of the right region. In FIG. 27, in a case where the CU is divided, the numbers of pixels in the width direction of the right region is no longer the power of 2. On the other hand, the number of pixels in the height direction of the right region is a power of 2. Here, it is illustrated that the orthogonal transform is executed for a maximum region in which the number of pixels in the width direction is the power of 2, in the right region. That is, it is illustrated that the orthogonal transform is executed for a rectangular maximum region in which the number of pixels is the power of 2, in the right region. Then, it is illustrated that the orthogonal transform is not executed in the remaining region except the maximum region.

### First Modification of Fourth Embodiment

In the fourth embodiment described above, the orthogonal transform has been executed for the maximum region in which the numbers of pixels in the height direction and the width direction are the power of 2 from the CU in which the number of pixels in either the height direction or the width direction after the CU is divided is not the power of 2. In a first modification of the fourth embodiment, a process of dividing a maximum region in which the number of pixels in the height direction or the width direction is the power of 2 from a region remaining in the orthogonal transform for the maximum region and executing the orthogonal transform for the divided region is recursively repeated. That is, the division of the maximum region and the orthogonal transform for the divided region are recursively repeated until a region in which the orthogonal transform is not executed disappears.

[Coding Processing of Image Coding Device 12 According to First Modification of Fourth Embodiment]

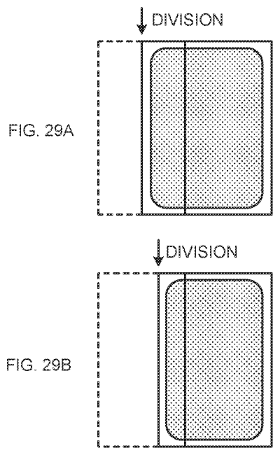

FIG. 28 is a diagram illustrating an example of a case where orthogonal transform is recursively executed in a maximum region in which the number of pixels is the power of 2 with respect to the region remaining in the orthogonal transform according to the first modification of the fourth embodiment of the present disclosure. Then, in FIG. 28, the maximum region in which the number of pixels is the power of 2 is divided from the left side. In addition, in FIG. 28, an entire right region remaining after executing the orthogonal transform for a left region is the maximum region in which the number of pixels is the power of 2. Therefore, it is illustrated that the maximum region is divided and the orthogonal transform is executed for the divided right region. In addition, FIGS. 28(a) and 28(b) illustrate different division positions. That is, the control unit 101 further divides a maximum region in which the number of pixels in the height direction or the width direction is the power of 2 from the region remaining in the orthogonal transform for the maximum region. In addition, the control unit 101 causes the orthogonal transform unit 113 to execute the orthogonal transform for the divided maximum region. Then, the control unit 101 repeatedly executes processing for dividing the maximum region and executing the orthogonal transform in the divided region until a region in which the number of pixels in the height direction or the width direction is not the power of 2 disappears.

In addition, FIG. 29 is a diagram illustrating an example of a case where orthogonal transform is recursively executed in a maximum region in which the number of pixels is the power of 2 with respect to a region remaining in the orthogonal transform according to the first modification of the fourth embodiment of the present disclosure. In FIG. 28, the maximum region in which the number of pixels is the power of 2 is divided from the left side, while in FIG. 29, division of a region from the right side and orthogonal transform are executed.

[Decoding Processing of Image Decoding Device 13 According to First Modification of Fourth Embodiment]

The image decoding device 13 executes inverse orthogonal transform for each region in which the orthogonal transform is executed.

<Configuration Example of Computer>

Next, the series of processing described above can be performed by hardware or can be performed by software. In a case where the series of processing is performed by the software, programs configuring the software are installed in a general-purpose computer or the like.

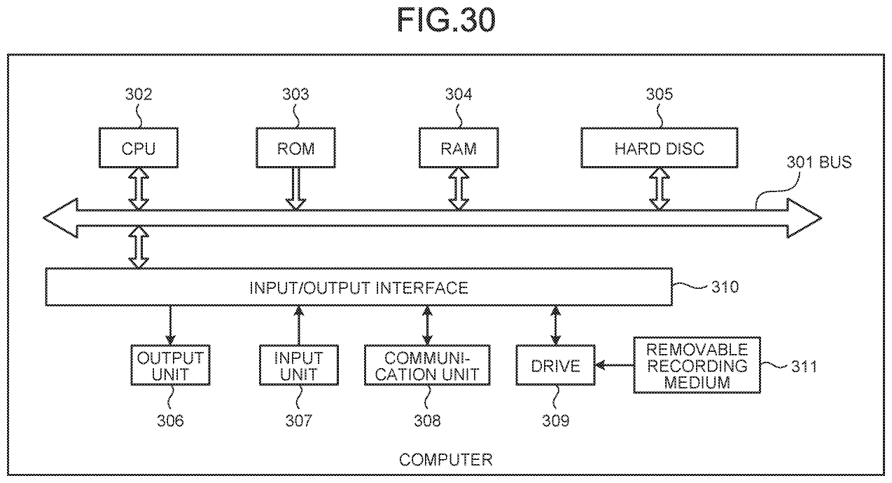

FIG. 30 is a block diagram illustrating a configuration example of an embodiment of a computer on which a program for executing the series of processing described above is installed.

The program can be recorded in advance on a hard disc 305 or a read only memory (ROM) 303 as a recording medium built in the computer.

Alternatively, the program can be stored (recorded) on a removable recording medium 311 driven by a drive 309. Such a removable recording medium 311 can be provided as so-called package software. Here, examples of the removable recording medium 311 include a flexible disc, a compact disc read only memory (CD-ROM), a magneto optical (MO) disc, a digital versatile disc (DVD), a magnetic dis, a semiconductor memory, and the like.

Note that the program can be installed on the computer from the removable recording medium 311 as described above or can be downloaded to the computer via a communication network or a broadcasting network and installed on the hard disc 305 built in the computer. That is, for example, the program can be transferred in a wireless manner from a download site to the computer via an artificial satellite for digital satellite broadcasting or be transferred in a wired manner to the computer via a network such as a local area network (LAN) or the Internet.

The computer has a central processing unit (CPU) 302 built therein, and an input/output interface 310 is connected to the CPU 302 via a bus 301.

When a command is input by a user through the input/output interface 310 by operating an input unit 307, the CPU 302 executes the program stored in the read only memory (ROM) 303 according to the command. Alternatively, the CPU 302 loads the program stored in the hard disc 305 into a random access memory (RAM) 304 and executes the program.

As a result, the CPU 302 performs the processing according to the flowcharts described above or the processing performed by the configurations of the block diagrams described above. Then, the CPU 302 outputs a processing result from an output unit 306, transmits the processing result from a communication unit 308, or records the processing result on the hard disc 305 via, for example, the input/output interface 310, as needed.

Note that the input unit 307 is composed of a keyboard, a mouse, a microphone, or the like. In addition, the output unit 306 is composed of a liquid crystal display (LCD), a speaker, or the like.

Here, in the present specification, processing performed by the computer according to the program does not necessarily need to be performed in time series in the order described as the flowchart. That is, the processing performed by the computer according to the program also includes processing executed in parallel or individually (for example, parallel processing or processing by an object).

In addition, the program may be processed by one computer (processor) or may be distributed and processed by a plurality of computers. Further, the program may be transferred to and executed in a remote computer.

Further, in the present specification, the system means a set of a plurality of components (devices, modules (parts), or the like), and it does not matter whether or not all the components are in the same housing. Therefore, both of a plurality of devices housed in separate housings and connected to each other via a network and one device in which a plurality of modules is housed in one housing are systems.

In addition, for example, the configuration described as one device (or processing unit) may be divided and configured as a plurality of devices (or processing units). Conversely, the configurations described as a plurality of devices (or processing units) in the above may be gathered and configured as one device (or processing unit). In addition, it goes without saying that configurations other than those described above may be added to the configuration of each device (or each processing unit). Further, some of configurations of any device (or processing unit) may be included in the configurations of another device (or another processing unit) if a configuration or an operation of the entire system is substantially the same.

In addition, for example, the present technology can have a configuration of cloud computing in which one function is shared and jointly processed by a plurality of devices through a network.

In addition, for example, the program described above can be executed in any device. In that case, it is sufficient if the device can have necessary functions (functional blocks and the like) to obtain necessary information.

In addition, for example, the respective steps described in the flowchart described above can be executed by one device or can be executed in a shared manner by a plurality of devices. Further, in a case where a plurality of processing is included in one step, the plurality of processing included in one step can be executed by one device or can be executed in a shared manner by a plurality of devices. In other words, the plurality of processing included in one step can be executed as processing of a plurality of steps. Conversely, the processing described as a plurality of steps can be collectively executed as one step.

Note that in the program executed by the computer, processing of steps describing the program may be executed in time series according to the order described in the present specification or may be executed in parallel or individually at a necessary timing such as a timing when a call is made, or the like. That is, as long as a contradiction does not occur, the processing of the respective steps may be performed in order different from the order described above. Further, processing of a step describing this program may be executed in parallel with processing of another program or may be executed in combination with the processing of another program.

Note that the present technology described plural times in the present specification can be implemented independently alone as long as a contradiction does not occur. Of course, a plurality of present technologies may be used in combination with one another. For example, a part or the entirety of the present technology described in any of the embodiments can be implemented in combination with a part or the entirety of the present technology described in the other embodiments. In addition, a part or the entirety of any the present technology described above may be implemented in combination with other technologies that are not described above.

<Application Target of Present Technology>

The present technology can be applied to an arbitrary image coding/decoding method. That is, specifications of various processing regarding image coding/decoding, such as transform (inverse transform), quantization (inverse quantization), coding (decoding), prediction, and the like are arbitrary and are not limited to the examples described above, as long as they do not contradict the present technology described above. In addition, some of these processing may be omitted as long as they do not contradict the present technology described above.

In addition, the present technology can be applied to a multi-viewpoint image coding/decoding system that codes/decodes a multi-viewpoint image including an image of a plurality of viewpoints (views). In that case, it is sufficient to apply the present technology to coding/decoding of each viewpoint (view).

Further, the present technology can be applied to a hierarchical image coding (scalable coding)/decoding system that codes/decodes a hierarchical image layered plural times so as to have a scalability function for a predetermined parameter. In that case, it is sufficient to apply the present technology to coding/decoding of each layer.

The image coding device or the image decoding device according to the embodiment can be applied to various electronic apparatuses such as, for example, a transmitter or a receiver (for example, a television receiver or a mobile phone) in satellite broadcasting, cable broadcasting of a cable television (TV) or the like, distribution on the Internet, and distribution to a terminal by cellular communication, a device (for example, a hard disc recorder or a camera) that records an image on media such as an optical disc, a magnetic disc, a flash memory, and the like, or reproduces an image from these storage media, or the like.

In addition, the present technology can be implemented as all configurations mounted in a device configuring an arbitrary device or system, for example, a processor as a system large scale integration (LSI) or the like (for example, a video processor), a module using a plurality of processors or the like (for example, a video module), a unit using a plurality of modules or the like (for example, a video unit), a set in which other functions are further added to the unit (for example, a video set), or the like (in other words, some of the configurations of the device).

In addition, the present technology can also be applied to a network system composed of a plurality of devices. For example, the present technology can be applied to a cloud service that provides a service regarding an image (moving image) to an arbitrary terminal such as a computer, an audio visual (AV) device, a portable information processing terminal, an Internet of things (IoT) device, and the like.

Note that a system, a device, a processing unit, or the like, to which the present technology is applied can be used in any field such as, for example, traffic, medical care, crime prevention, agriculture, livestock industry, mining industry, beauty, factory, home appliance, weather, nature monitoring, and the like. In addition, an application of the present technology is also arbitrary.

For example, the present technology can be applied to a system or a device used for providing an ornamental content or the like. In addition, for example, the present technology can be applied to a system or a device used for traffic such as traffic situation monitoring, automatic driving control or the like. Further, for example, the present technology can also be applied to a system or a device used for security. In addition, for example, the present technology can be applied to a system or a device used for automatic control of a machine or the like. Further, for example, the present technology can also be applied to a system or a device used for agriculture and livestock industry. In addition, for example, the present technology can also be applied to a system or a device for monitoring a state of nature such as a volcano, a forest, an ocean, and the like, or wildlife. Further, for example, the present technology can also be applied to a system or a device used for sports.

Note that effects described in the present specification are merely examples and are not limited, and other effects may be provided.

Note that the present technology can also have the following configuration.

(1)

An image processing device comprising:

an orthogonal transform unit that executes orthogonal transform for a block obtained by dividing an image; and

a control unit that controls the orthogonal transform unit depending on whether or not the number of pixels in a height direction or a width direction of the block is a power of 2.

(2)

The image processing device according to (1),

wherein the control unit controls the orthogonal transform unit so as not to execute the orthogonal transform in a case where the number of pixels of the block is not the power of 2.

(3)

The image processing device according to (1) or (2), further comprising

a quantization unit that executes quantization,

wherein the control unit controls the quantization unit so as to execute the quantization without causing the orthogonal transform unit to execute the orthogonal transform in a case where the number of pixels of the block is not the power of 2.

(4)

The image processing device according to any one of (1) to (3),

wherein the control unit controls whether to execute inter-prediction that generates a prediction image based on an image different from an image to be processed or intra-prediction that generates a prediction image based on the image to be processed, depending on whether or not the number of pixels of the block is the power of 2.

(5)

The image processing device according to (4),

wherein the control unit performs control to execute the inter-prediction in a case where the number of pixels of the block is not the power of 2.

(6)

The image processing device according to (4), further comprising

an output unit that outputs prediction mode information indicating which of the inter-prediction and the intra-prediction is executed,

wherein the control unit controls the output unit so as not to output the prediction mode information in a case where the number of pixels of the block is not the power of 2.

(7)

The image processing device according to (6),

wherein the control unit performs control to execute the inter-prediction in a case where the prediction mode information is not provided.

(8)

The image processing device according to any one of (1) to (7),

wherein the control unit controls the orthogonal transform unit so as to execute the orthogonal transform in a case where a size of the block in which the number of pixels in the height direction or the width direction is not the power of 2 is smaller than a threshold value.

(9)

The image processing device according to any one of (1) to (8),

wherein the control unit divides the block in which the number of pixels in the height direction or the width direction is not the power of 2, so as to form a block in which the numbers of pixels in the height direction and the width direction are the power of 2, and the orthogonal transform unit executes the orthogonal transform for the block divided by the control unit.

(10)

The image processing device according to any one of (1) to (9),

wherein the control unit controls the orthogonal transform unit so as to execute the orthogonal transform in a direction in which the number of pixels is the power of 2, in a case where the number of pixels in either the height direction or the width direction of the block is not the power of 2.

(11)

The image processing device according to (1),

wherein the control unit controls the orthogonal transform unit so as to execute the orthogonal transform for a maximum region in which the numbers of pixels in the height direction and the width direction are the power of 2 inside the block in which the numbers of pixels in the height direction and the width direction are not the power of 2.

(12)

The image processing device according to (11),

wherein the control unit controls the orthogonal transform unit so as to execute the orthogonal transform for the maximum region of a position where a cost is low when the orthogonal transform is executed among a plurality of the maximum regions.

(13)

The image processing device according to (11) or (12),

wherein the control unit performs control to output position information indicating a position of the maximum region in which the orthogonal transform is executed.

(14)

The image processing device according to any one of (11) to (13),

wherein the control unit controls the orthogonal transform unit so as not to execute the orthogonal transform in a remaining region except the maximum region in the block.

(15)

The image processing device according to any one of (11) to (14),

wherein the control unit performs control to repeatedly execute processing for dividing the maximum region from the block in which the number of pixels in the height direction or the width direction is not the power of 2 and causing the orthogonal transform unit to execute the orthogonal transform in the maximum region, until the block in which the number of pixels in the height direction or the width direction is not the power of 2 disappears.

(16)

An image processing method comprising:

executing orthogonal transform for a block obtained by dividing an image; and

controlling the orthogonal transform depending on whether or not the number of pixels in a height direction or a width direction of the block is a power of 2.

(17)

An image processing program for causing a computer included in an image processing device to function as:

an orthogonal transform unit that executes orthogonal transform for a block obtained by dividing an image; and

a control unit that controls the orthogonal transform unit depending on whether or not the number of pixels in a height direction or a width direction of the block is a power of 2.

### REFERENCE SIGNS LIST

11 IMAGE PROCESSING SYSTEM
12 IMAGE CODING DEVICE
13 IMAGE DECODING DEVICE
21 IMAGE PROCESSING CHIP
22 EXTERNAL MEMORY
23 CODING CIRCUIT
24 CACHE MEMORY
31 IMAGE PROCESSING CHIP
32 EXTERNAL MEMORY
33 DECODING CIRCUIT
34 CACHE MEMORY
101 CONTROL UNIT
122 PREDICTION UNIT
113 ORTHOGONAL TRANSFORM UNIT
115 CODING UNIT
118 INVERSE ORTHOGONAL TRANSFORM UNIT
120 IN-LOOP FILTER UNIT
212 DECODING UNIT
214 INVERSE ORTHOGONAL TRANSFORM UNIT
216 IN-LOOP FILTER UNIT
219 PREDICTION UNIT

1. An image processing device comprising:
an orthogonal transform unit that executes orthogonal transform for a block obtained by dividing an image; and
a control unit that controls the orthogonal transform unit depending on whether or not the number of pixels in a height direction or a width direction of the block is a power of 2.

2. The image processing device according to claim 1,
wherein the control unit controls the orthogonal transform unit so as not to execute the orthogonal transform in a case where the number of pixels of the block is not the power of 2.

3. The image processing device according to claim 1, further comprising
a quantization unit that executes quantization,
wherein the control unit controls the quantization unit so as to execute the quantization without causing the orthogonal transform unit to execute the orthogonal transform in a case where the number of pixels of the block is not the power of 2.

4. The image processing device according to claim 1,
wherein the control unit controls whether to execute inter-prediction that generates a prediction image based on an image different from an image to be processed or intra-prediction that generates a prediction image based on the image to be processed, depending on whether or not the number of pixels of the block is the power of 2.

5. The image processing device according to claim 4,
wherein the control unit performs control to execute the inter-prediction in a case where the number of pixels of the block is not the power of 2.

6. The image processing device according to claim 4, further comprising
an output unit that outputs prediction mode information indicating which of the inter-prediction and the intra-prediction is executed,
wherein the control unit controls the output unit so as not to output the prediction mode information in a case where the number of pixels of the block is not the power of 2.

7. The image processing device according to claim 6,
wherein the control unit performs control to execute the inter-prediction in a case where the prediction mode information is not provided.

8. The image processing device according to claim 1,
wherein the control unit controls the orthogonal transform unit so as to execute the orthogonal transform in a case where a size of the block in which the number of pixels in the height direction or the width direction is not the power of 2 is smaller than a threshold value.

9. The image processing device according to claim 1,
wherein the control unit divides the block in which the number of pixels in the height direction or the width direction is not the power of 2, so as to form a block in which the numbers of pixels in the height direction and the width direction are the power of 2, and
the orthogonal transform unit executes the orthogonal transform for the block divided by the control unit.

10. The image processing device according to claim 1,
wherein the control unit controls the orthogonal transform unit so as to execute the orthogonal transform in a direction in which the number of pixels is the power of 2, in a case where the number of pixels in either the height direction or the width direction of the block is not the power of 2.

11. The image processing device according to claim 1,
wherein the control unit controls the orthogonal transform unit so as to execute the orthogonal transform for a maximum region in which the numbers of pixels in the height direction and the width direction are the power of 2 inside the block in which the numbers of pixels in the height direction and the width direction are not the power of 2.

12. The image processing device according to claim 11,
wherein the control unit controls the orthogonal transform unit so as to execute the orthogonal transform for the maximum region of a position where a cost is low when the orthogonal transform is executed among a plurality of the maximum regions.

13. The image processing device according to claim 11,
wherein the control unit performs control to output position information indicating a position of the maximum region in which the orthogonal transform is executed.

14. The image processing device according to claim 11,
wherein the control unit controls the orthogonal transform unit so as not to execute the orthogonal transform in a remaining region except the maximum region in the block.

15. The image processing device according to claim 11,
wherein the control unit performs control to repeatedly execute processing for dividing the maximum region from the block in which the number of pixels in the height direction or the width direction is not the power of 2 and causing the orthogonal transform unit to execute the orthogonal transform in the maximum region, until the block in which the number of pixels in the height direction or the width direction is not the power of 2 disappears.

16. An image processing method comprising:
executing orthogonal transform for a block obtained by dividing an image; and
controlling the orthogonal transform depending on whether or not the number of pixels in a height direction or a width direction of the block is a power of 2.

17. An image processing program for causing a computer included in an image processing device to function as:
an orthogonal transform unit that executes orthogonal transform for a block obtained by dividing an image; and
a control unit that controls the orthogonal transform unit depending on whether or not the number of pixels in a height direction or a width direction of the block is a power of 2.
